(19) United States
(12) Patent Application Publication
(10) Pub. No.: US 2012/0033046 A1
(43) Pub. Date: Feb. 9, 2012

(54) IMAGE PROCESSING APPARATUS, IMAGE PROCESSING METHOD, AND PROGRAM

(75) Inventor: Koji OZAKI, Kanagawa (JP)

(73) Assignee: SONY CORPORATION, Tokyo (JP)

(21) Appl. No.: 13/194,480

(22) Filed: Jul. 29, 2011

(30) Foreign Application Priority Data
Aug. 6, 2010 (JP) 2010-176897

(51) Int. Cl. H04N 13/02; G06T 15/00

(52) U.S. Cl. 348/46; 345/419; 348/E13.074

(57) ABSTRACT

Provided is an image processing apparatus including: an acquisition unit which acquires stereoscopic image information used for displaying a stereoscopic image on a display unit; a controller which performs one of a first control of allowing the stereoscopic image to be displayed as a planar image on the display unit and a second control of performing an image process on the stereoscopic image so that a parallax direction of the stereoscopic image and a parallax direction of the display unit are coincident with each other and allowing the stereoscopic image, which is subject to the image process, to be displayed on the display unit in the case where a parallax direction of the stereoscopic image displayed on the display unit and a parallax direction of the display unit are not coincident with each other based on the stereoscopic image information.

### BACKGROUND

The present disclosure relates to an image processing apparatus, and more particularly, to an image processing apparatus and an image processing method of displaying a stereoscopic image and a program allowing a computer to execute the method.

In recent years, image capturing apparatuses such as a digital still camera or a digital video camera (for example, camera-integrated recorder) which captures an image of a subject such as a person or an animal to generate a captured image (image data) and records the captured image as image content have become widespread.

In addition, recently, a number of stereoscopic image displaying methods of displaying a stereoscopic image capable of obtaining stereoscopic viewing by using parallax between left and right eyes have been disclosed. In addition, the image capturing apparatuses such as a digital still camera or a digital video camera (for example, camera-integrated recorder) which record image data used for displaying a stereoscopic image as image content (stereoscopic image content) have been disclosed.

Since the stereoscopic image content are recorded by the image capturing apparatus in this manner, it is considered that, for example, the recorded stereoscopic image content are allowed to be displayed on a display unit of the image capturing apparatus. For example, an information apparatus having a stereoscopic image display mode of displaying a stereoscopic image, which is configured by using two images generated through an image capturing operation, on a display unit has been disclosed (refer to, for example, Japanese Unexamined Patent Application Publication No. 2004-112111 (FIGS. 4A and 4B)).

### SUMMARY

In the related art, the stereoscopic image generated through the image capturing operation may be allowed to be displayed on the display unit of the information apparatus.

However, it may be considered that, for example, the stereoscopic image which is to be displayed on the display unit is rotated by the user manipulation to be displayed. In this case, the parallax direction of the stereoscopic image and the parallax direction of the display unit, on which the stereoscopic image is to be displayed, may be not be coincident with each other, so that the stereoscopic image may not properly be displayed. In this manner, due to the rotation or the like of the stereoscopic image according to the user manipulation, the stereoscopic image may not be properly displayed, and the image may not be seen by a user.

It is desirable to properly display an image at the time of displaying a stereoscopic image.

According to a first embodiment of the present disclosure, there are provided an image processing apparatus including: an acquisition unit which acquires stereoscopic image information used for displaying a stereoscopic image on a display unit; a controller which performs one of a first control of allowing the stereoscopic image to be displayed as a planar image on the display unit and a second control of performing an image process on the stereoscopic image so that a parallax direction of the stereoscopic image and a parallax direction of the display unit are coincident with each other and allowing the stereoscopic image, which is subject to the image process, to be displayed on the display unit in the case where a parallax direction of the stereoscopic image displayed on the display unit and a parallax direction of the display unit are not coincident with each other based on the stereoscopic image information, an image processing method thereof, and a program allowing a computer to execute the method. Accordingly, in the case where the parallax direction of the stereoscopic image displayed on the display unit and the parallax direction of the display unit are not coincident with each other, it is possible to obtain a function of performing one of the first control of allowing the stereoscopic image to be displayed as a planar image and the second control of performing an image process on the stereoscopic image so that the parallax direction of the stereoscopic image and the parallax direction of the display unit are coincident with each other and allowing the stereoscopic image, which is subject to the image process, to be displayed.

In addition, in the first embodiment of the present disclosure, in the case of performing the second control, the controller may perform control of performing a rotation process on the stereoscopic image so that the parallax direction of the stereoscopic image and the parallax direction of the display unit are coincident with each other and allowing the stereoscopic image, which is subject to the rotation process, to be displayed on the display unit. Accordingly, in the case where the second control is performed, it is possible to obtain a function of performing a rotation process on the stereoscopic image so that the parallax direction of the stereoscopic image and the parallax direction of the display unit are coincident with each other and allowing the stereoscopic image, which is subject to the rotation process, to be displayed on the stereoscopic image.

In addition, in the first embodiment of the present disclosure, the image processing apparatus may further include a manipulation receiving unit which receives rotation command manipulation for rotating the stereoscopic image which is to be displayed on the display unit, wherein if the rotation command manipulation is received in the case where the stereoscopic image is displayed on the display unit, the controller performs the first control in the case where the parallax direction of the stereoscopic image and the parallax direction of the display unit are not coincident with each other. Accordingly, if the rotation command manipulation is received in the case where the stereoscopic image is displayed on the display unit, it is possible to obtain a function of performing the first control in the case where the parallax direction of the stereoscopic image and the parallax direction of the display unit are not coincident with each other.

In addition, in the first embodiment of the present disclosure, the manipulation receiving unit may receive returning command manipulation for returning the rotation, which is based on the rotation command manipulation after receiving the rotation command manipulation, to an original state, and after the returning command manipulation is received in the case where the stereoscopic image is displayed on the display unit, the controller may perform the second control in the case where the parallax direction of the stereoscopic image and the parallax direction of the display unit are not coincident with each other. Accordingly, in the case where the stereoscopic image is displayed on the display unit, after the returning command manipulation is received, it is possible to obtain a function of performing the second control in the case where the parallax direction of the stereoscopic image and the parallax direction of the display unit are not coincident with each other.

In addition, in the first embodiment of the present disclosure, the stereoscopic image may be configured by multi-viewing-point images, and in the case where the first control is performed, the controller may perform control of allowing at least one viewing point image among the multi-viewing-point images to be displayed on the display unit. Accordingly, in the case where the first control is performed, it is possible to obtain a function of allowing at least one viewing point image among the multi-viewing-point images to be displayed.

In addition, in the first embodiment of the present disclosure, wherein the stereoscopic image information may include parallax information indicating the parallax direction of the stereoscopic image, which is displayed on the display unit based on the stereoscopic image information, at an image capturing operation time, and the controller may determine based on the parallax information included in the acquired stereoscopic image information whether or not the parallax direction of the stereoscopic image and the parallax direction of the display unit are coincident with each other. Accordingly, it is possible to obtain a function of determining based on the parallax information included in the stereoscopic image information whether or not the parallax direction of the stereoscopic image and the parallax direction of the display unit are coincident with each other.

In addition, in the first embodiment of the present disclosure, the image processing apparatus may further include: a first casing having the display unit; a second casing which is a casing different from the first casing; a rotating member which rotatably connects the first casing and the second casing; and a detection unit which detects a rotation state of the first casing with respect to the second casing, wherein the stereoscopic image information includes parallax information indicating the parallax direction of the stereoscopic image, which is displayed on the display unit based on the stereoscopic image information, at an image capturing operation time, and wherein the controller determines based on the parallax information included in the acquired stereoscopic image information and the detected rotation state of the first casing whether or not the parallax direction of the stereoscopic image and the parallax direction of the display unit are coincident with each other. Accordingly, it is possible to obtain a function of determining based on the parallax information included in the stereoscopic image information and the detected rotation state of the first casing whether or not the parallax direction of the stereoscopic image and the parallax direction of the display unit are coincident with each other.

In addition, in the first embodiment of the present disclosure, the display unit may be set so that one of a specific direction of the display screen and an orthogonal direction directing to the display screen is the parallax direction, and the controller may perform control of changing the parallax direction of the display unit based on the detected rotation state of the first casing. Accordingly, it is possible to obtain a function of changing the parallax direction of the display unit based on the detected rotation state of the first casing.

In addition, in the first embodiment of the present disclosure, in the case where the parallax direction of the stereoscopic image displayed on the display unit and the parallax direction of the display unit are not coincident with each other, the controller may perform one of the first control, the second control, and a third control of changing the parallax direction of the display unit so that the parallax direction of the display unit is coincident with the parallax direction of the stereoscopic image and allowing the stereoscopic image to be displayed on the display unit. Accordingly, in the case where the parallax direction of the stereoscopic image displayed on the display unit and the parallax direction of the display unit are not coincident with each other, it is possible to obtain a function of performing one of the first control, the second control, and the third control of changing the parallax direction of the display unit so that the parallax direction of the display unit is coincident with the parallax direction of the stereoscopic image and allowing the stereoscopic image to be displayed on the display unit.

In addition, in the first embodiment of the present disclosure, the display unit may be set so that one of a specific direction of the display screen and an orthogonal direction directing to the display screen is the parallax direction, and the controller may change the parallax direction of the display unit based on user manipulation or a posture of the display unit and determines whether or not the changed parallax direction of the display unit and the parallax direction of the stereoscopic image are coincident with each other. Accordingly, it is possible to obtain a function of changing the parallax direction of the display unit based on the user manipulation or the posture of the display unit and determining whether or not the changed parallax direction of the display unit and the parallax direction of the stereoscopic image are coincident with each other.

In addition, in the first embodiment of the present disclosure, the image processing apparatus may further include a manipulation receiving unit which receives selection manipulation for selecting whether the controller is allowed to perform the first control or the controller is allowed to perform the second control in the case where the parallax direction of the stereoscopic image displayed on the display unit and the parallax direction of the display unit are not coincident with each other, wherein in the case where the parallax direction of the stereoscopic image displayed on the display unit and the parallax direction of the display unit are not coincident with each other, the controller allows the image corresponding to the acquired stereoscopic image information to be displayed on the display unit according to the selected control. Accordingly, in the case where the parallax direction of the stereoscopic image displayed on the display unit and the parallax direction of the display unit are not coincident with each other, it is possible to obtain a function of displaying the image corresponding to the acquired stereoscopic image information according to the selected control.

In addition, in the first embodiment of the present disclosure, the image processing apparatus may further include: a detection unit which detects movement amounts and movement directions of a plurality of areas of the first image with respect to the second image based on the first image and the second image; and a composition unit which moves images of a plurality of areas of the second image based on the detected movement amounts and movement directions of the areas of the first image and generates a composed image based on the moved images, wherein in the case where the second control is performed, the controller allows the generated composed image and the second image to be displayed as the stereoscopic image on the display unit. Accordingly, it is possible to obtain a function of detecting the movement amounts and movement directions of the plurality of areas of the first image with respect to the second image based on the first image and the second image, moving the images of the plurality of areas of the second image based on the detected movement amounts and movement directions of the areas of the first image, generating the composed image based on the moved images, and allowing the generated composed image and the second image as the stereoscopic image in the case where the second control is performed.

In addition, in the first embodiment of the present disclosure, the image processing apparatus may further include an image capturing unit which image-captures a subject to generate a first image and a second image used for displaying the stereoscopic image for stereoscopically viewing the subject; a detection unit which detects movement amounts and movement directions of a plurality of areas of the first image with respect to the second image based on the generated first and second images; a composition unit which moves images of a plurality of areas of the second image based on the detected movement amounts and movement directions of the areas of the first image and generates a composed image based on the moved images; and a recording control unit which allows the generated composed image and the second image to be recorded as multi-viewing-point images included in the stereoscopic image information on a recording medium. Accordingly, it is possible to obtain a function of detecting the movement amounts and movement directions of the plurality of areas of the first image with respect to the second image based on the first image and the second image, moving the images of the plurality of areas of the second image based on the detected movement amounts and movement directions of the areas of the first image, generating the composed image based on the moved images, and allowing the generated composed image and the second image to be recorded as the multi-viewing-point image.

In addition, in the first embodiment of the present disclosure, the image processing apparatus may further include an image capturing unit which image-captures a subject to generate multi-viewing-point images used for displaying the stereoscopic image for stereoscopically viewing the subject; an image cutting unit which cuts a predetermined area of at least one end portion side among the two end portions in the longitudinal direction in each of the generated multi-viewing-point images; and a recording control unit which allows the multi-viewing-point images, in which the predetermined area is cut, to be included in the stereoscopic image information and to be recorded on a recording medium. Accordingly, it is possible to obtain a function of cutting a predetermined area of at least one end portion side among the two end portions in the longitudinal direction in each of the generated multi-viewing-point images and allowing the multi-viewing-point images, in which the predetermined area is cut, to be recorded.

In addition, in the first embodiment of the present disclosure, the image processing apparatus may further include an image capturing unit which image-captures a subject to generate a plurality of sets of image groups where sets of multi-viewing-point images used for displaying the stereoscopic image for stereoscopically viewing the subject are consecutively disposed in a time sequence; a composition unit which performs composition by using at least a portion of each of the plurality of the generated sets of the image groups to generate a plurality of composed images used for displaying the stereoscopic image for stereoscopically viewing the subject; and a recording control unit which allows the plurality of generated composed images to be recorded as multi-viewing-point images in the stereoscopic image information on a recording medium. Accordingly, it is possible to obtain a function of performing the composition by using at least a portion of each of the plurality of the generated sets of the image groups to generate the plurality of composed images and allowing the plurality of generated composed images to be recorded as the multi-viewing-point images.

In addition, according to a second embodiment of the present disclosure, there are provided an image processing apparatus including: a parallax direction acquisition unit which acquires a parallax direction of a user; an acquisition unit which acquires stereoscopic image information used for displaying a stereoscopic image on a display unit; and a controller which performs one of a first control of allowing the stereoscopic image to be displayed as a planar image on the display unit, a second control of performing an image process on the stereoscopic image so that a parallax direction of the stereoscopic image and the acquired parallax direction are coincident with each other and allowing the stereoscopic image, which is subject to the image process, to be displayed on the display unit, and a third control of changing the parallax direction of the display unit so that the parallax direction of the stereoscopic image and the acquired parallax direction are coincident with each other and allowing the stereoscopic image to be displayed on the display unit in the case where the parallax direction of the stereoscopic image displayed on the display unit and the acquired parallax direction are not coincident with each other based on the stereoscopic image information, an image processing method, and a program allowing a computer to execute the method. Accordingly, in the case where the parallax direction of the stereoscopic image displayed on the display unit and the parallax direction of the user are not coincident with each other, it is possible to obtain a function of performing one of the first control of allowing the stereoscopic image to be displayed as a planar image, the second control of performing an image process on the stereoscopic image so that the parallax direction of the stereoscopic image and the parallax direction of the user are coincident with each other and allowing the stereoscopic image, which is subject to the image process, to be displayed, and the third control of changing the parallax direction of the display unit so that the parallax direction of the stereoscopic image and the parallax direction of the user are coincident with each other and allowing the stereoscopic image to be displayed.

In addition, according to a third embodiment of the present disclosure, there are provided an image processing apparatus including: an acquisition unit which acquires stereoscopic image information used for displaying a stereoscopic image on a display unit; and a controller which performs control of allowing the stereoscopic image to be displayed as a planar image on the display unit in the case where the parallax direction of the stereoscopic image displayed on the display unit and the parallax direction of the display unit are not coincident with each other based on the stereoscopic image information, an image processing method, and a program allowing a computer to execute the method. Accordingly, in the case where the parallax direction of the stereoscopic image displayed on the display unit and the parallax direction of the display unit are not coincident with each other, it is possible to obtain a function of allowing the stereoscopic image to be displayed as a planar image.

In addition, according to a fourth embodiment of the present disclosure, there are provided an image processing apparatus including: an acquisition unit which acquires stereoscopic image information used for displaying a stereoscopic image on a display unit; and a controller which performs control of performing an image process on the stereoscopic image so that a parallax direction of the stereoscopic image and a parallax direction of the display unit are coincident with each other and allowing the stereoscopic image, which is subject to the image process, to be displayed on the display unit in the case where the parallax direction of the stereoscopic image displayed on the display unit and the parallax direction of the display unit are not coincident with each other based on the stereoscopic image information, an image processing method, and a program allowing a computer to execute the method. Accordingly, in the case where the parallax direction of the stereoscopic image displayed on the display unit and the parallax direction of the display unit are not coincident with each other, it is possible to obtain a function of performing the image process on the stereoscopic image so that the parallax direction of the stereoscopic image and the parallax direction of the display unit are coincident with each other and allowing the stereoscopic image, which is subject to the image process, to be displayed.

According to the present disclosure, at the time of displaying the stereoscopic image, it is possible to obtain an excellent effect capable of properly displaying the image.

### BRIEF DESCRIPTION OF THE DRAWINGS

FIGS. 1A to 1C are perspective diagrams illustrating outer appearance of an image capturing apparatus according to a first embodiment of the present disclosure.

FIG. 2 is a block diagram illustrating an example of functional configuration of the image capturing apparatus according to the first embodiment of the present disclosure.

FIGS. 3A to 3C are schematic diagrams illustrating an example (parallax barrier type) of a display type for displaying a stereoscopic image on a display unit according to the first embodiment of the present disclosure.

FIGS. 4A and 4B are diagrams illustrating an example of displaying the display unit and an example of retained content of a preference information retention unit according to the first embodiment of the present disclosure.

FIGS. 5A and 5B are diagrams illustrating an example of display control in the case of changing an image displayed on the display unit according to a change of a posture of the display unit according to the first embodiment of the present disclosure.

FIGS. 6A to 6C are diagrams illustrating an example of display control in the case of changing an image displayed on the display unit according to user manipulation from a manipulation receiving unit or a change of a posture of the display unit according to the first embodiment of the present disclosure.

FIGS. 7A to 7D are diagrams illustrating a relationship between a parallax direction of the display unit and a parallax direction of the stereoscopic image displayed on the display unit according to the first embodiment of the present disclosure.

FIGS. 8A to 8C are diagrams illustrating a relationship between the parallax direction of the display unit and the parallax direction of the stereoscopic image displayed on the display unit according to the first embodiment of the present disclosure.

FIGS. 9A and 9B are diagrams illustrating an example of an image capturing operation state performed by using the image capturing apparatus and a stereoscopic image generated through the image capturing operation according to the first embodiment of the present disclosure.

FIGS. 10A to 10C are diagrams illustrating a relationship between the parallax direction of the display unit and the parallax direction of the stereoscopic image displayed on the display unit according to the first embodiment of the present disclosure.

FIGS. 11A and 11B are schematic diagrams illustrating an example of display control in the case where the parallax direction of the display unit and the parallax direction of the stereoscopic image displayed on the display unit are not coincident with each other according to the first embodiment of the present disclosure.

FIGS. 12A and 12B are schematic diagrams illustrating an example of display control in the case where the parallax direction of the display unit and the parallax direction of the stereoscopic image displayed on the display unit are not coincident with each other according to the first embodiment of the present disclosure.

FIGS. 13A and 13B are schematic diagrams illustrating an example of display control in the case where the parallax direction of the display unit and the parallax direction of the stereoscopic image displayed on the display unit are not coincident with each other according to the first embodiment of the present disclosure.

FIGS. 14A and 14B are schematic diagrams illustrating an example of display control in the case where the parallax direction of the display unit and the parallax direction of the stereoscopic image displayed on the display unit are not coincident with each other according to the first embodiment of the present disclosure.

FIGS. 15A to 15D are schematic diagrams illustrating an example of display control in the case of displaying a planar image on the display unit according to the first embodiment of the present disclosure.

FIGS. 16A to 16D are diagrams illustrating an image generation example in the case of generating a vertically long stereoscopic image by using the image capturing apparatus according to the first embodiment of the present disclosure.

FIGS. 17A to 17C are diagrams illustrating another image generation example in the case of generating the vertically long stereoscopic image by using the image capturing apparatus according to the first embodiment of the present disclosure.

FIGS. 18A to 18C are diagrams illustrating still another image generation example in the case of generating the vertically long stereoscopic image by using the image capturing apparatus according to the first embodiment of the present disclosure.

FIG. 19 is a block diagram illustrating an example of functional configuration of the image capturing apparatus according to the first embodiment of the present disclosure.

FIGS. 20A and 20B are diagrams illustrating a relationship between the parallax direction of the display unit and the parallax direction of the stereoscopic image displayed on the display unit according to the first embodiment of the present disclosure.

FIGS. 21A to 21C are schematic diagrams illustrating an image capturing operation state performed by using the image capturing apparatus and a flow in the case of changing the parallax direction of the stereoscopic image according to the first embodiment of the present disclosure.

FIGS. 22A to 22C are schematic diagrams illustrating a flow in the case of changing the parallax direction of the stereoscopic image by the captured-image signal processing unit according to the first embodiment of the present disclosure.

FIGS. 23A to 23C are schematic diagrams illustrating a flow in the case of changing the parallax direction of the stereoscopic image by the captured-image signal processing unit according to the first embodiment of the present disclosure.

FIGS. 24A and 24B are schematic diagrams illustrating a flow in the case of changing the parallax direction of the stereoscopic image by the captured-image signal processing unit according to the first embodiment of the present disclosure.

FIG. 25 is a flowchart illustrating an example of a process procedure of an image display control process of the image capturing apparatus according to the first embodiment of the present disclosure.

FIG. 26 is a flowchart illustrating an example of a process procedure of the image display control process of the image capturing apparatus according to the first embodiment of the present disclosure.

FIG. 27 is a flowchart illustrating an example of a process procedure of the image display control process of the image capturing apparatus according to the first embodiment of the present disclosure.

FIG. 28 is a flowchart illustrating an example of a process procedure of a stereoscopic image recording control process of the image capturing apparatus according to the first embodiment of the present disclosure.

FIG. 29 is a flowchart illustrating an example of a process procedure of the stereoscopic image recording control process of the image capturing apparatus according to the first embodiment of the present disclosure.

FIG. 30 is a flowchart illustrating an example of a process procedure of the stereoscopic image recording control process of the image capturing apparatus according to the first embodiment of the present disclosure.

FIGS. 31A and 31B are schematic diagrams illustrating an example (special-purpose glasses type) of a display type for displaying a stereoscopic image on an image processing apparatus according to a modified example of the first embodiment of the present disclosure.

FIGS. 32A and 32B are diagrams illustrating an example of a configuration of outer appearance and an example of a functional configuration of an image capturing apparatus according to a modified example of the first embodiment of the present disclosure.

FIGS. 33A and 33B are diagrams illustrating an example of a configuration of outer appearance and an example of a functional configuration of an image capturing apparatus according to a modified example of the first embodiment of the present disclosure.

FIGS. 34A and 34B are diagrams illustrating an example of configuration of outer appearance of a mobile phone apparatus according to a modified example of the first embodiment of the present disclosure.

### DETAILED DESCRIPTION OF EMBODIMENTS

Hereinafter, embodiments for carrying out the present disclosure (hereinafter, referred to as embodiments) will be described. The description will be made in the following order.

1. First Embodiment (Display Control: Example of Displaying Image Based on User Settings in Case where Parallax Direction of Display Unit and Parallax Direction of Stereoscopic Image Displayed on Display Unit are Not Coincident with each other)

2. Modified Example

3. Modified Example

### 1. First Embodiment

### [Example of Configuration of Outer Appearance of Image Capturing Apparatus]

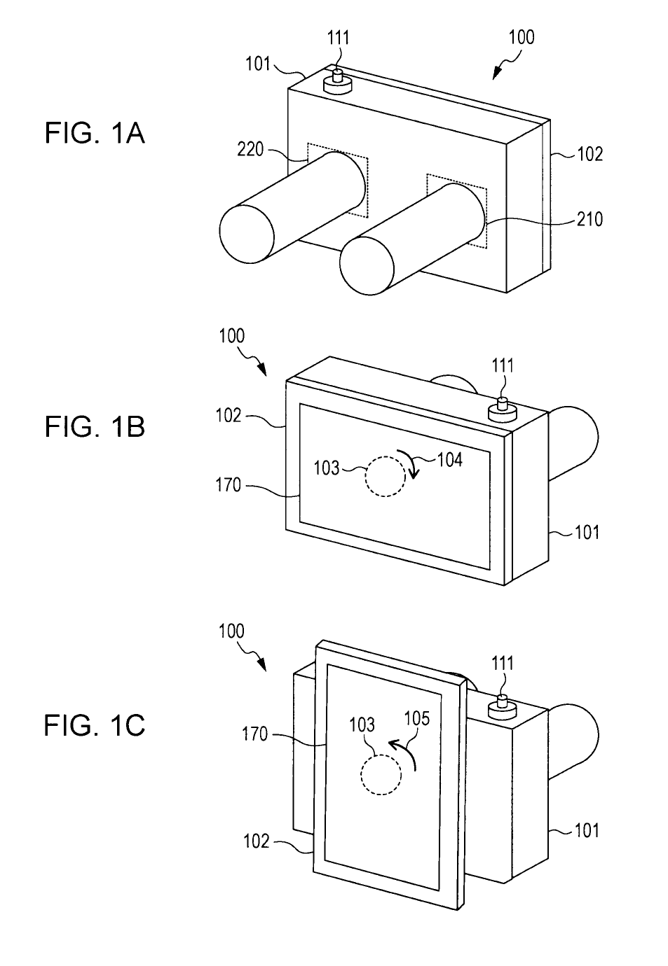

FIGS. 1A to 1C are perspective diagrams illustrating outer appearance of an image capturing apparatus 100 according to a first embodiment of the present disclosure.

FIG. 1A is a perspective diagram illustrating the outer appearance of the front surface (that is, the surface where a lens directed to a subject is disposed) side of the image capturing apparatus 100. In addition, FIGS. 1B and 1C are perspective diagrams illustrating the outer appearance of the rear surface (that is, the surface where a display unit 170 directed to a photographing person is disposed) side of the image capturing apparatus 100.

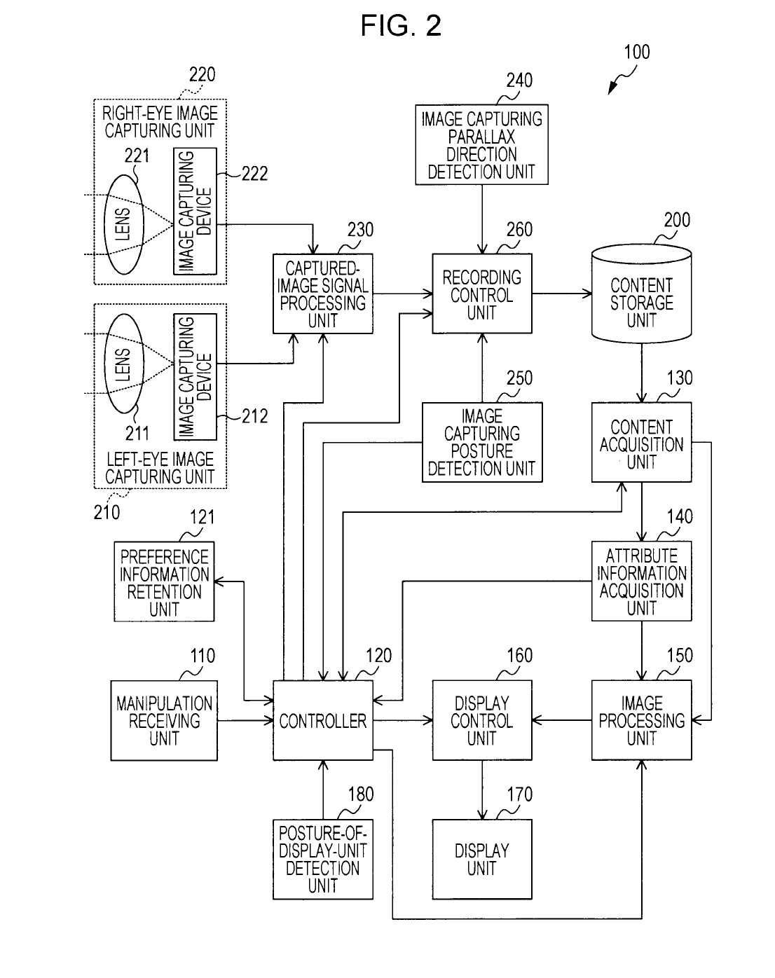

The image capturing apparatus 100 includes a shutter button 111, a display unit 170, a left-eye image capturing unit 210, and a right-eye image capturing unit 220. The image capturing apparatus 100 is an image capturing apparatus capable of image-capturing the subject to generate a captured image (image data) and recording the generated captured image as image content (still image content or moving image content) in a content storage unit 200 (illustrated in FIG. 2). In addition, the image capturing apparatus 100 is an image capturing apparatus adapted to stereoscopic image capturing and may generate the image content for displaying a stereoscopic image (3D image). In addition, the stereoscopic image (3D image) is a multi-viewing-point image through which stereoscopic viewing may be obtained by using a parallax between the left and right eyes. For example, the left-eye image capturing unit 210 and the right-eye image capturing unit 220 individually image-capture the subject to generate two captured images (a left-eye viewing image (left-eye image) and a right-eye viewing image (right-eye image) for displaying the stereoscopic image). Next, the image content for displaying the stereoscopic image is generated based on the generated two captured images. The image capturing apparatus 100 is implemented, for example, by an image capturing apparatus such as a digital still camera having a plurality of image capturing functions. In addition, in FIGS. 1A to 10, for convenience of the description, the image capturing apparatus 100 is simplified in the illustration, and a power switch or the like which is disposed on the outer side surface of the image capturing apparatus 100 is omitted in the illustration.

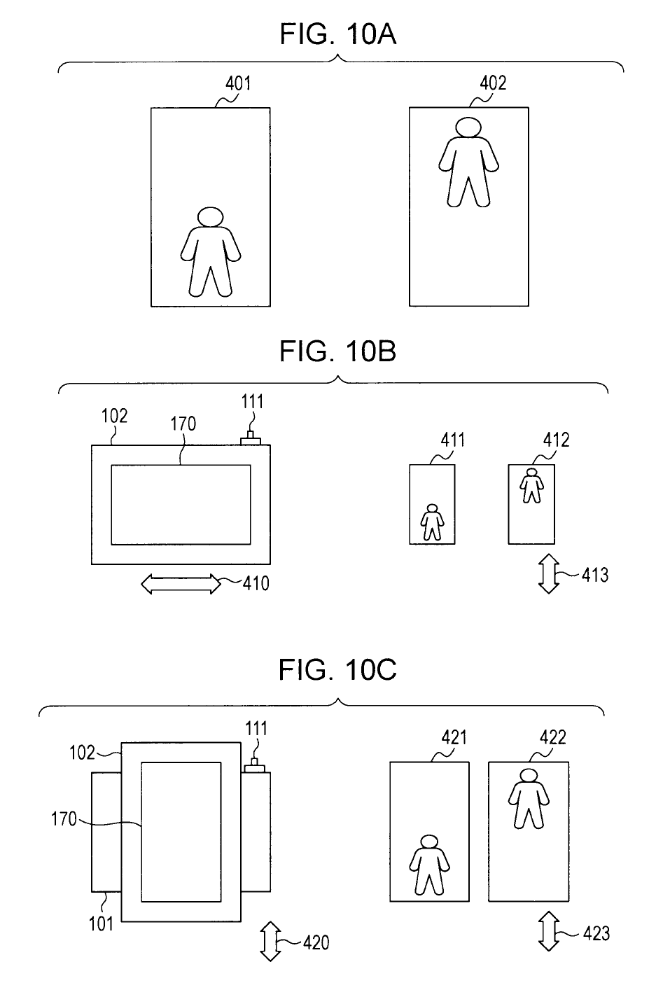

The image capturing apparatus 100 includes a first casing 101 and a second casing 102. In addition, the first casing 101 and the second casing 102 are rotatably connected to each other by using a rotating member 103 (indicated by a dotted line) as a rotation reference. Accordingly, a relative position relationship of the second casing 102 with respect to the first casing 101 may be changed. For example, in the case where the second casing 102 is rotated by 90 degree in the direction of arrow 104 illustrated in FIG. 1B, the state of the image capturing apparatus 100 is illustrated in FIG. 10.

Herein, in the first embodiment of the present disclosure, as illustrated in FIG. 1B, a state where the longitudinal direction of the first casing 101 and the longitudinal direction of the second casing 102 are set to be the same direction is referred to as a horizontally long state of the second casing 102 (the display unit 170). In addition, as illustrated in FIG. 10, a state where the longitudinal direction of the first casing 101 and the longitudinal direction of the second casing 102 are set to be substantially perpendicular to each other is referred to as a vertically long state of the second casing 102 (the display unit 170).

The first casing 101 includes a shutter button 111, a left-eye image capturing unit 210, and a right-eye image capturing unit 220.

The shutter button 111 is a manipulation member of commanding the image recording start. For example, in the case where a still image capturing mode is set, the shutter button 111 is pressed when the image data generated by the left-eye image capturing unit 210 and the right-eye image capturing unit 220 are recorded as a still image file on a recording medium.

The left-eye image capturing unit 210 and the right-eye image capturing unit 220 are configured to image-capture the subject to the image data. As illustrated in FIG. 1A, in the first embodiment of the present disclosure, the left-eye image capturing unit 210 and the right-eye image capturing unit 220 where the two lens groups are disposed to be aligned in a specific direction are exemplified in the description. Herein, for example, in the case where the longitudinal direction of the first casing 101 is set to be coincident with a horizontal direction, the specific direction may be set to the horizontal direction.

The second casing 102 includes a display unit 170. The display unit 170 is a display unit for displaying various images. For example, an image corresponding to the image content stored in the content storage unit 200 (illustrated in FIG. 2) is displayed on the display unit 170 based on display command manipulation of a user. In addition, for example, an image generated through the image capturing operation is displayed as a monitoring image on the display unit 170. As the display unit 170, for example, an LCD (Liquid Crystal Display) panel, an organic EL (Electro Luminescence) panel, or the like may be used. In addition, the display unit 170 may be configured by using a touch panel, so that the manipulation input from the user may be received through the detection of touch manipulation in the display unit 170.

In addition, the left-eye image capturing unit 210 and the right-eye image capturing unit 220 are described in detail with reference to FIG. 2.

### [Example of Functional Configuration of Image Capturing Apparatus]

FIG. 2 is a block diagram illustrating an example of functional configuration of the image capturing apparatus 100 according to the first embodiment of the present disclosure. The image capturing apparatus 100 includes a manipulation receiving unit 110, a controller 120, a preference information retention unit 121, a content acquisition unit 130, an attribute information acquisition unit 140, an image processing unit 150, a display control unit 160, a display unit 170, and a posture-of-display-unit detection unit 180. In addition, the image capturing apparatus 100 includes a content storage unit 200, a left-eye image capturing unit 210, a right-eye image capturing unit 220, a captured-image signal processing unit 230, the image capturing parallax direction detection unit 240, an image capturing posture detection unit 250, and a recording control unit 260.

The content storage unit 200 is configured to store the images, which are output from the captured-image signal processing unit 230, in a correspondence manner as an image file (the image content) based on control of the recording control unit 260. In addition, the content storage unit 200 supplies the stored image content to the content acquisition unit 130. In addition, as the content storage unit 200, for example, a removable recording medium (one or a plurality of the recording media) such as a disc such as a DVD (Digital Versatile Disc) or a semiconductor memory such as a memory card may be used. In addition, such a recording medium may be built in the image capturing apparatus 100; and otherwise, the recording medium may be detachably provided to the image capturing apparatus 100.

The left-eye image capturing unit 210 and the right-eye image capturing unit 220 are configured so that a pair of left and right optical systems and a pair of left and right image capturing devices are disposed in order to generate the left-eye viewing image and the right-eye viewing image. In addition, configurations (lens, image capturing device, and the like) of the left-eye image capturing unit 210 and the right-eye image capturing unit 220 are substantially the same except that the arrangement positions are different. Therefore, hereinafter, with respect to one of the left and right configurations, some portions thereof are omitted in the description. In addition, the left-eye image capturing unit 210 and the right-eye image capturing unit 220 are examples of an image capturing unit disclosed in the embodiments of the present disclosure.

The left-eye image capturing unit 210 includes a lens 211 and an image capturing device 212. In addition, the right-eye image capturing unit 220 includes a lens 221 and an image capturing device 222. In addition, in FIG. 2, for convenience of the description, the left-eye image capturing unit 210 and the right-eye image capturing unit 220 are simplified in the illustration, and a diaphragm, a lens driving unit, or the like may be omitted in the illustration.

The lens 211 is a lens group (for example, a focus lens and a zoom lens) which condenses light incident from a subject. The light condensed by the lens group is incident on the image capturing device 212 with the amount (light amount) being adjusted by a diaphragm (not shown).

The image capturing device 212 is an image capturing device which perform a photoelectric conversion process on incident light transmitting through the lens 211 and supplies the photoelectrically-converted electrical signal (image signal) to the captured-image signal processing unit 230. In other words, the image capturing device 212 receives light incident from the subject through the lens 211 and performs photoelectric conversion to generate an analog image signal according to a received light amount. In addition, the image capturing device 212 and the image capturing device 222 (the right-eye image capturing unit 220) forms images through synchronization driving with respect to the subject images incident through the lenses to generate the analog image signals. In this manner, the analog image signal generated by the image capturing device 212 and the analog image signal generated by the image capturing device 222 are supplied to the captured-image signal processing unit 230. In addition, as the image capturing devices 212 and 222, a CCD (Charge Coupled Device), a CMOS (Complementary Metal-Oxide Semiconductor), or the like may be used.

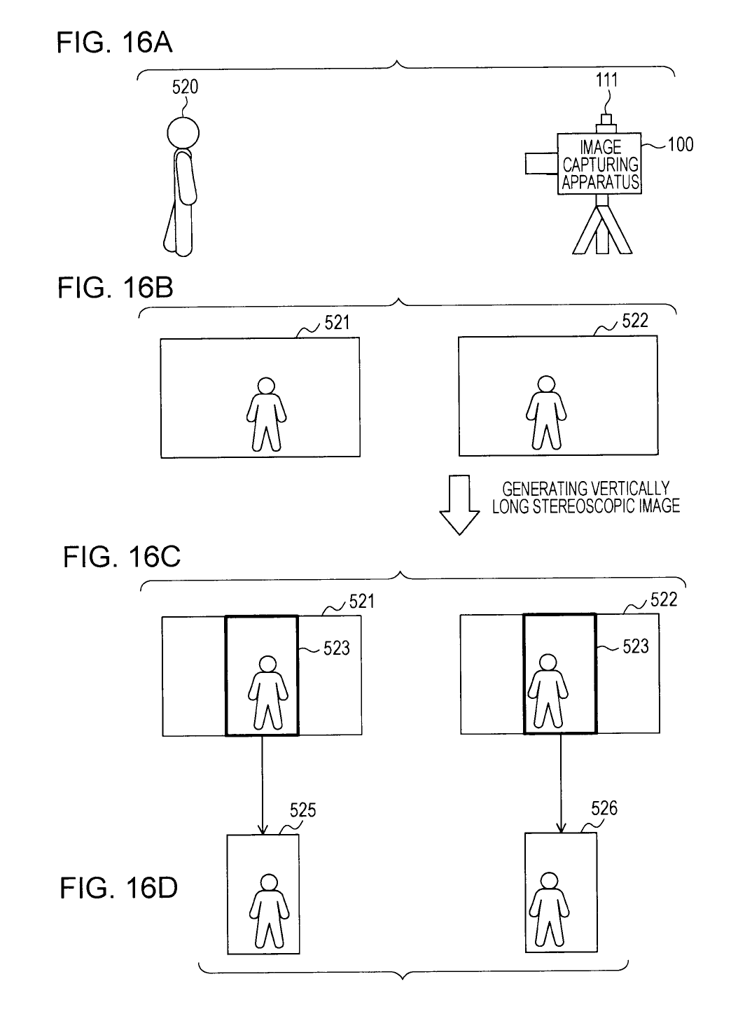

The captured-image signal processing unit 230 is a captured-image signal processing unit which applies various signal processes on the analog image signal supplied from the image capturing devices 212 and 222 based on control of the controller 120. Next, the captured-image signal processing unit 230 outputs digital image signals (left-eye viewing image and right-eye viewing image), which are generated through the various signal processes, to the recording control unit 260. For example, the captured-image signal processing unit 230 generates the stereoscopic image (vertically long stereoscopic image) of which the parallax direction is the horizontal direction and of which the longitudinal direction is the vertical direction based on the control of the controller 120. In addition, a vertically long stereoscopic image generating method will be described in detail with reference to FIGS. 16A to 16D to FIGS. 24A and 24B. In addition, the vertically long stereoscopic image may be configured to be generated by the image processing unit 150 at the displaying time. In addition, the captured-image signal processing unit 230 is an example of the image cutting unit, the detection unit, and the composition unit disclosed in the embodiment of the present disclosure.

The image capturing parallax direction detection unit 240 detects the parallax direction at the image capturing operation time and outputs the detected parallax direction (image capturing parallax direction) to the recording control unit 260. In addition, in the image capturing operation at the normal time, the horizontal direction of the captured image is detected as the parallax direction.

The image capturing posture detection unit 250 detects acceleration, motion, tilt, or the like of the image capturing apparatus 100 to detect a change of the posture of the image capturing apparatus 100 at the image capturing operation time and acquires the posture information (image capturing posture) of the image capturing time based on a result of the detection. Next, the image capturing posture detection unit 250 outputs the acquired image capturing posture (for example, a rotation angle (for example, 0 degree, 90 degrees, 180 degrees, or 270 degrees) using the optical axis direction as a rotation axis) to the recording control unit 260. In addition, the image capturing posture detection unit 250 may be implemented by a gyro sensor (angular velocity sensor) or an acceleration sensor.

The recording control unit 260 is configured to record the images, which are output from the captured-image signal processing unit 230, as an image file (image content) in the content storage unit 200 based on control of the controller 120. For example, in the case where the still image recording command manipulation is received by the manipulation receiving unit 110, the recording control unit 260 allows the left-eye viewing image and the right-eye viewing image to be recorded in a correspondence manner as still image file (still image content) in the content storage unit 200. At the recording time, attribute information including date information, image capturing parallax direction (parallax information), image capturing posture, and the like of the image capturing time are recorded as the image file (for example, recording of rotation information or the like of Exif (Exchangeable image file format)). In addition, the still image recording command manipulation is performed, for example, by the pressing manipulation of the shutter button 111 (illustrated in FIGS. 1A to 10). In addition, for example, the recording control unit 260 may allow the order relationship (for example, viewing point numbers) of the left-eye viewing image and the right-eye viewing image to be recorded in correspondence with the left-eye viewing image and the right-eye viewing image as an MP (Multi Picture) file on the recording medium. In this case, the attribute information including the date information, the image capturing parallax direction, the image capturing posture, and the like of the image capturing time are recorded as attachment information of the MP file. The MP file is a file based on an MP format where a plurality of still images are recorded as one file (extension: .MPO).

In addition, for example, the case where the moving image recording command manipulation is received by the manipulation receiving unit 110 is considered. In this case, the recording control unit 260 allows the left-eye viewing image and the right-eye viewing image which are output in a predetermined frame rate from the captured-image signal processing unit 230 to be sequentially recorded as a moving image file (moving image content) in the content storage unit 200. In addition, the moving image recording command manipulation is performed, for example, by the pressing manipulation of the recording button.

The manipulation receiving unit 110 is a manipulation receiving unit which receives manipulation input of the user and supplies a manipulation signal according to the content of the received manipulation input to the controller 120. For example, in the stereoscopic image display mode, the manipulation receiving unit 110 receives setting manipulation for setting content of control which is to be preferentially performed at the time of displaying the stereoscopic image on the display unit 170. In addition, for example, the manipulation receiving unit 110 receives setting manipulation for setting the stereoscopic image recording mode or command manipulation for commanding image recording.

In addition, for example, the manipulation receiving unit 110 receives rotation command manipulation for rotating the stereoscopic image which is to be displayed on the display unit 170. In addition, for example, the manipulation receiving unit 110 receives returning command manipulation for returning the rotation based on the rotation command manipulation to the original state after the reception of the rotation command manipulation. The image processing unit 150 performs an image process on the stereoscopic image, which is to be displayed on the display unit 170, based on the command manipulation.

The controller 120 is configured to control components of the image capturing apparatus 100 based on the manipulation content from the manipulation receiving unit 110. For example, in the case where the setting manipulation for setting the content of control which is to be preferentially performed is received by the manipulation receiving unit 110, the controller 120 allows preference information according to the setting manipulation to be retained in the preference information retention unit 121.

In addition, for example, in the case where the stereoscopic image is displayed on the display unit 170 based on the image content (stereoscopic image content), the controller 120 determines whether or not the parallax direction of the stereoscopic image displayed on the display unit 170 and the parallax direction of the display unit 170 are coincident with each other. For example, the controller 120 determines whether or not the two parallax directions are coincident with each other based on the image capturing parallax direction included in the attribute information (attribute information included in the image content) acquired by the attribute information acquisition unit 140 and the rotation state of the display unit 170 (the first casing 101). In addition, in the case where the display unit 170 (the first casing 101) is in the horizontally long state, it is determined based on the image capturing parallax direction included in the attribute information whether or not the parallax direction of the stereoscopic image and the parallax direction of the display unit 170 are coincident with each other.

Next, if the parallax direction of the stereoscopic image displayed on the display unit 170 and the parallax direction of the display unit 170 are not coincident with each other, the controller 120 performs one of a first control and a second control. The first control is a control for allowing the stereoscopic image to be displayed as a planar image on the display unit 170. In addition, the second control is a control for allowing the image processing unit 150 to perform an image process on the stereoscopic image so that the parallax direction of the stereoscopic image and the parallax direction of the display unit 170 are coincident with each other and for allowing the stereoscopic image, which is subject to the image process, to be displayed on the display unit 170. In addition, in the case of performing the second control, for example, the image processing unit 150 is allowed to perform the rotation process on the stereoscopic image so that the parallax direction of the stereoscopic image and the parallax direction of the display unit 170 are coincident with each of the, and the stereoscopic image, which is subject to the rotation process, is allowed to be displayed on the display unit 170.

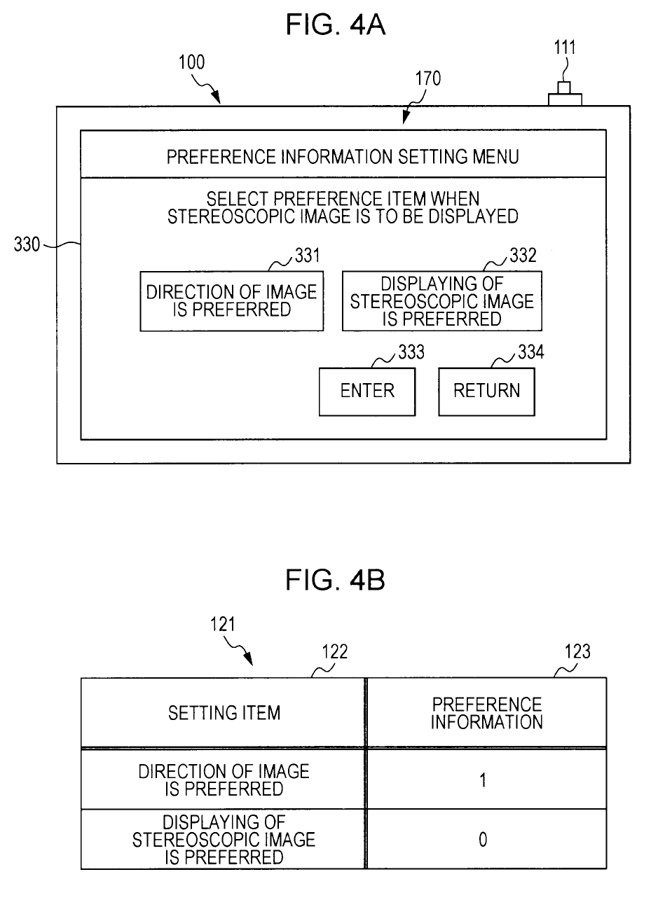

In addition, in the case where the parallax direction of the stereoscopic image displayed on the display unit 170 and the parallax direction of the display unit 170 are not coincident with each other, which one of the first control and the second control is to be performed may be set, for example, through a setting screen 330 illustrated in FIG. 4A.

Herein, with respect to the display unit 170, any one of a specific direction (for example, the longitudinal direction) of the display screen and an orthogonal direction directing toward the display unit 170 may be set as the parallax direction. With respect to the parallax direction, changing thereof according to the posture of the display unit 170 or fixing thereof irrespective of the posture of the display unit 170 may be set by the user manipulation. For example, in the case where the changing thereof according to the posture of the display unit 170 is set, the controller 120 performs control for changing the parallax direction of the display unit 170 based on the rotation state of the display unit 170 (the first casing 101) detected by the posture-of-display-unit detection unit 180. In this manner, in the case where the parallax direction of the display unit 170 is changed, it is determined whether or not the changed parallax direction of the display unit 170 and the parallax direction of the stereoscopic image are coincident with each other.

In addition, in the case where the fixing thereof irrespective of the posture of the display unit 170 is set, the case where the parallax direction of the stereoscopic image displayed on the display unit 170 and the parallax direction of the display unit 170 are not coincident with each other is considered. In this case, besides the first control and the second control, a third control for changing the parallax direction of the display unit 170 so that the parallax direction of the display unit 170 is coincident with the parallax direction of the stereoscopic image and for allowing the stereoscopic image to be displayed on the display unit 170 may be performed.

In addition, for example, in the case where the stereoscopic image is displayed on the display unit 170, if the parallax direction of the stereoscopic image and the parallax direction of the display unit are not coincident with each other through reception of the rotation command manipulation, the controller 120 performs the first control. On the other hand, in the case where the stereoscopic image is displayed on the display unit 170, if the parallax direction of the stereoscopic image and the parallax direction of the display unit 170 are not coincident with each other after reception of the returning command manipulation, the controller 120 performs the second control.

The preference information retention unit 121 retains the content of control, which is to be preferentially performed at the time of displaying the stereoscopic image on the display unit 170, as the preference information and supplies the retained preference information to the controller 120. In addition, the preference information retained in the preference information retention unit 121 is updated by the controller 120 every time when the setting manipulation for setting the preference information is received by the manipulation receiving unit 110. In addition, with the retained content of the preference information retention unit 121 will be described with reference to FIG. 4B.

The content acquisition unit 130 is configured to acquire the image content (the stereoscopic image information) stored in the content storage unit 200 and to supply the acquired image content to the attribute information acquisition unit 140 and the image processing unit 150 based on control of the controller 120. In addition, the content acquisition unit 130 is an example of an acquisition unit disclosed in the embodiments of the present disclosure.

The attribute information acquisition unit 140 is configured to acquire the attribute information included in the image content acquired by the content acquisition unit 130 and to supply the acquired attribute information to the controller 120 and the image processing unit 150. The attribute information includes, for example, the date information, the image capturing parallax direction, the image capturing posture, and the like of the image capturing time.

The image processing unit 150 is configured to perform various image processes for displaying the images on the display unit 170 on the images corresponding to the image content acquired by the content acquisition unit 130 based on control of the controller 120. For example, the image processing unit 150 performs an image process for displaying the stereoscopic image on the display unit 170 based on the image content acquired by the content acquisition unit 130 and the attribute information acquired by the attribute information acquisition unit 140. In addition, in the case where the changing manipulation (for example, the rotation command manipulation) for changing the stereoscopic image, which is to be displayed on the display unit 170, is performed by the manipulation receiving unit 110, the image processing unit 150 performs an image process according to the changing manipulation. In addition, the image processing unit 150 is an example of a detection unit and a composition unit disclosed in the embodiments of the present disclosure.

The display control unit 160 is configured to allow the images, on which the image process is performed by the image processing unit 150, to be displayed on the display unit 170 based on control of the controller 120. For example, in the case where the command manipulation for displaying the stereoscopic image (the still image) is received the manipulation receiving unit 110, the display control unit 160 allows the stereoscopic image, on which the image process is performed by the image processing unit 150, to be displayed on the display unit 170. In addition, the display control unit 160 allows various screens (for example, a setting screen 330 illustrated in FIG. 4A) to be displayed on the display unit 170 based on control of the controller 120.

The display unit 170 is a display unit for displaying the image content stored in the content storage unit 200 based on control of the display control unit 160. In addition, various menu screens or various images are displayed on the display unit 170.

The posture-of-display-unit detection unit 180 is configured to detect the posture of the display unit 170 and to output a result of the detection to the controller 120. In other words, the posture-of-display-unit detection unit 180 detects the rotation state of the second casing 102 with respect to the first casing 101. For example, the posture-of-display-unit detection unit 180 detects an angle formed by the first casing 101 and the second casing 102 as a rotation state of the second casing 102 with respect to the first casing 101 and outputs a result of the detection to the controller 120. For example, an angle detection switch which is not pressed in the case where the rotation angle of the second casing 102 with respect to the first casing 101 is less than a predetermined value and which is pressed in the case where the rotation angle is equal to or more than the predetermined value is disposed at a portion of the rotating member 103. Next, the posture-of-display-unit detection unit 180 detects the angle formed by the first casing 101 and the second casing 102 by using the angle detection switch. For example, the posture-of-display-unit detection unit 180 detects the angle formed by the first casing 101 and the second casing 102 in units of 90 degrees. In addition, as the posture-of-display-unit detection unit 180, an aspect detection sensor (for example, an acceleration sensor) for detecting the posture of the display unit 170 (for example, the vertical state or the horizontal state) irrespective of the rotation state with respect to the first casing 101 may be used. In addition, the posture-of-display-unit detection unit 180 is an example of a detection unit disclosed in the embodiments of the present disclosure.

In addition, as described above, although the image capturing apparatus 100 may perform the recording process on any one of the moving image and the still image, hereinafter, the generation process and the recording process for the still image are mainly described.

### [Example of Stereoscopic Image Display Type (Parallax Barrier Type)]

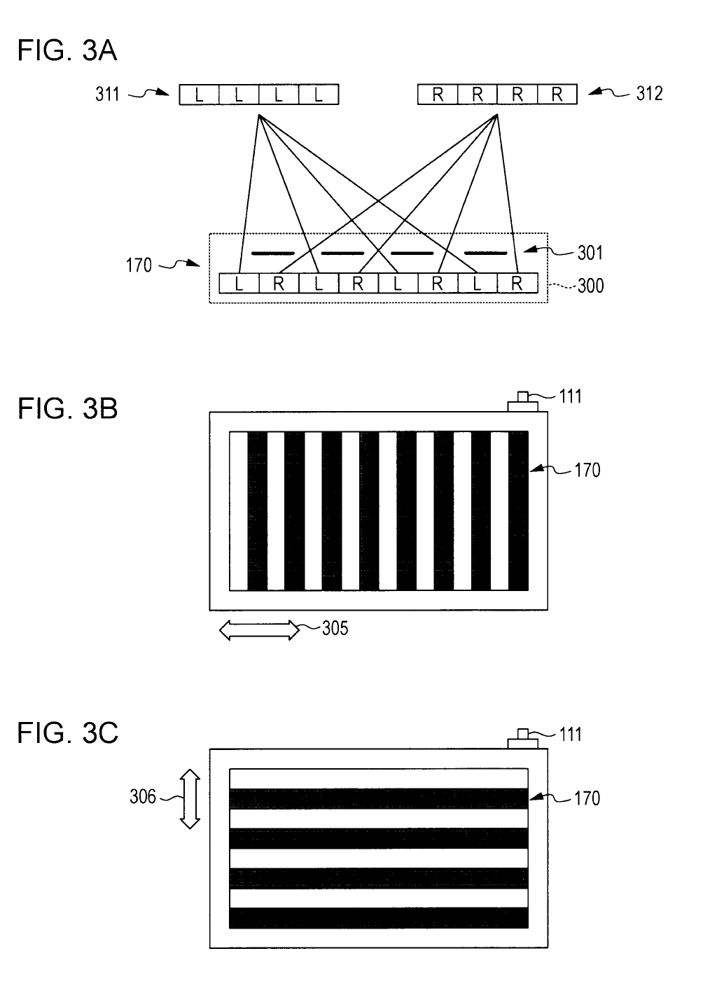

FIGS. 3A to 3C are schematic diagrams illustrating an example (parallax barrier type) of a display type for displaying the stereoscopic image on the display unit 170 according to the first embodiment of the present disclosure.

FIG. 3A schematically illustrates the parallax barrier type which is an example of a type for displaying the stereoscopic image on the display unit 170. In FIG. 3A, inside a dotted rectangle 300 (rectangle schematically indicating the display unit 170), the left-eye viewing image in the stereoscopic image which becomes a display object is schematically indicated by “L”, and the right-eye viewing image is schematically indicated by “R”.

In addition, in FIG. 3A, a parallax barrier 301 (parallax barrier 301 formed inside the display unit 170) formed between the stereoscopic image which becomes the display object and a user is schematically indicated by a bold line. In addition, in FIG. 3A, the image (left-eye viewing image 311) which passes through the parallax barrier 301 to reach user's left eye is indicated by “L”; and the image (right-eye viewing image 312) which passes through the parallax barrier 301 to reach user's right eye is indicated by “R”. In this manner, the parallax barrier 301 is formed between the stereoscopic image which becomes the display object and the user, and the left-eye viewing image 311 and the right-eye viewing image 312 pass through the parallax barrier 301 to reach user's left and right eyes, so that the user may properly see the stereoscopic image. Herein, the parallax barrier 301 is formed by using liquid crystal, or the like. In addition, the parallax direction may be changed according to user manipulation, a change of the posture of the display unit 170, or the like. An example of a change of the parallax direction is illustrated in FIGS. 3B and 3C.

FIGS. 3B and 3C schematically illustrate the parallax barrier (indicated by gray) in the display unit 170. More specifically, FIG. 3B illustrates the parallax barrier in the case where the parallax direction of the display unit 170 is the left and right directions (directions indicated by arrow 305); and FIG. 3C illustrates the parallax barrier in the case where the parallax direction of the display unit 170 is the up and down directions (directions indicated by arrow 306). In addition, in the example illustrated in FIGS. 3B and 3C, for convenience of the description, the interval of the parallax barrier is indicated to be relatively wide.

Herein, as described above, with respect to the parallax direction of the display unit 170, it may be set by the user manipulation whether the parallax direction of the display unit 170 is changed according to the posture of the display unit 170 or the parallax direction of the display unit 170 is fixed irrespective of the posture of the display unit 170. For example, in the case where the parallax direction is set to be changed according to the posture of the display unit 170, the controller 120 perform control of changing the parallax direction of the display unit 170 based on the rotation state of the display unit 170 (first casing 101) detected by the posture-of-display-unit detection unit 180. For example, in the case where the display unit 170 is in the horizontally long state, the parallax direction (directions indicated by arrow 305) illustrated FIG. 3B is set; and in the case where the display unit 170 is in the vertically long state, the parallax direction (directions indicated by arrow 306) illustrated in FIG. 3C is set.

### [Example of Setting Preference Information]

FIGS. 4A and 4B are diagrams illustrating an example of displaying of the display unit 170 and an example of retained content of the preference information retention unit 121 according to the first embodiment of the present disclosure. The setting screen 330 illustrated in FIG. 4A is a screen displayed on the display unit 170 at the time of setting the content of the control which is to be preferentially performed when the stereoscopic image is to be displayed on the display unit 170. For example, just after the setting manipulation of the stereoscopic image capturing mode for displaying the stereoscopic image is performed, the setting screen 330 is displayed. On the setting screen 330, selection buttons 331 and 332, an enter button 333, and a return button 334 are disposed.

The selection button 331 and the selection button 332 are buttons which are pressed at the time of setting the content of the control which is to be preferentially performed when the stereoscopic image is to be displayed on the display unit 170. Herein, the selection button 331 is a button which is pressed at the time of setting the performance of the first control in the case where the parallax direction of the stereoscopic image displayed on the display unit 170 and the parallax direction of the display unit 170 are not coincident with each other. On the other hand, the selection button 332 is a button which is pressed at the time of setting the performance of the second control in the case where the parallax directions are not coincident with each other. For example, in the case where the display unit 170 is constructed with a touch panel, the to-be-preferentially-performed control content may be set as preference information by performing pressing manipulation of a desired button in the display unit 170. The preference information will be described in detail with reference to FIG. 4B.

The enter button 333 is a button which is pressed at the time of determining the selection after the pressing manipulation of selecting the to-be-preferentially-performed control content is performed. In addition, the preference information (to-be-preferentially-performed control content) which is determined by the pressing manipulation of the enter button 333 is retained in the preference information retention unit 121. The return button 334 is a button which is pressed, for example, in the case of returning to the display screen which is displayed just before.

FIG. 4B illustrates an example of retained content of the preference information retention unit 121. The preference information retention unit 121 retains the to-be-preferentially-performed control content of the time of displaying the stereoscopic image on the display unit 170 as the preference information, so that the preference information 123 for each the setting items 122 is retained.

The setting items 122 are items which are the object of the user setting manipulation on the setting screen 330 illustrated in FIG. 4A. In addition, the preference information 123 is preference information which is set by the user setting manipulation on the setting screen 330 illustrated in FIG. 4A. For example, as the preference information 123, “1” is retained in the setting item 122 which is determined as the to-be-preferentially-performed control content by the user manipulation. On the other hand, “0” retained in the setting item 122 which is not determined as the to-be-preferentially-performed control content.

The example illustrated in FIG. 4B illustrates the case where “direction of image is preferred (first control)” is set as the to-be-preferentially-performed control content by the setting manipulation on the setting screen 330.

### [Example of Display Control According to Change of Posture of Display Unit]

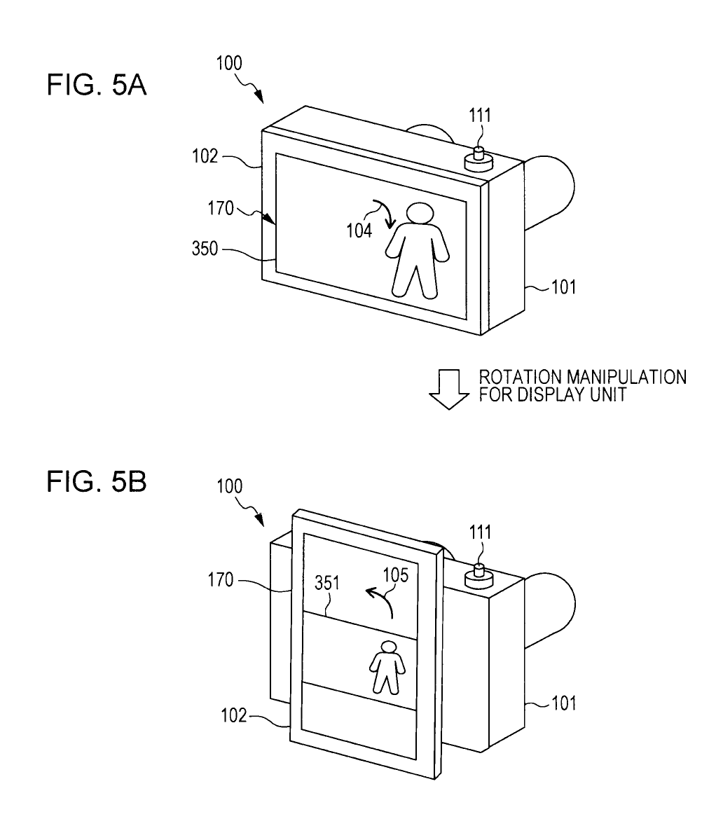

FIGS. 5A and 5B are diagrams illustrating an example of display control in the case of changing an image displayed on the display unit 170 according to a change of a posture of the display unit 170 according to the first embodiment of the present disclosure. FIG. 5A illustrates an example of displaying an image 350 in the case where the display unit 170 is set to be in the horizontally long state. The image 350 is set as a planar image which includes one person. FIG. 5B illustrates an example of displaying in the case where the display unit 170 (the second casing 102) is rotated by 90 degrees in the direction of arrow 104 in this state.

FIG. 5B illustrates an example of displaying an image 351 in the case where the display unit 170 is set to be in the vertically long state. The image 351 is set as a planar image which is obtained by reducing the image 350 illustrated in FIG. 5A. More specifically, the image processing unit 150 reduces the image 350 so that the horizontal length of the image 350 illustrated in FIG. 5A is equal to the length of the display area in the horizontal direction of the display unit 170 illustrated in FIG. 5B. Next, the display control unit 160 allows the reduced image 351 to be displayed on the display unit 170.

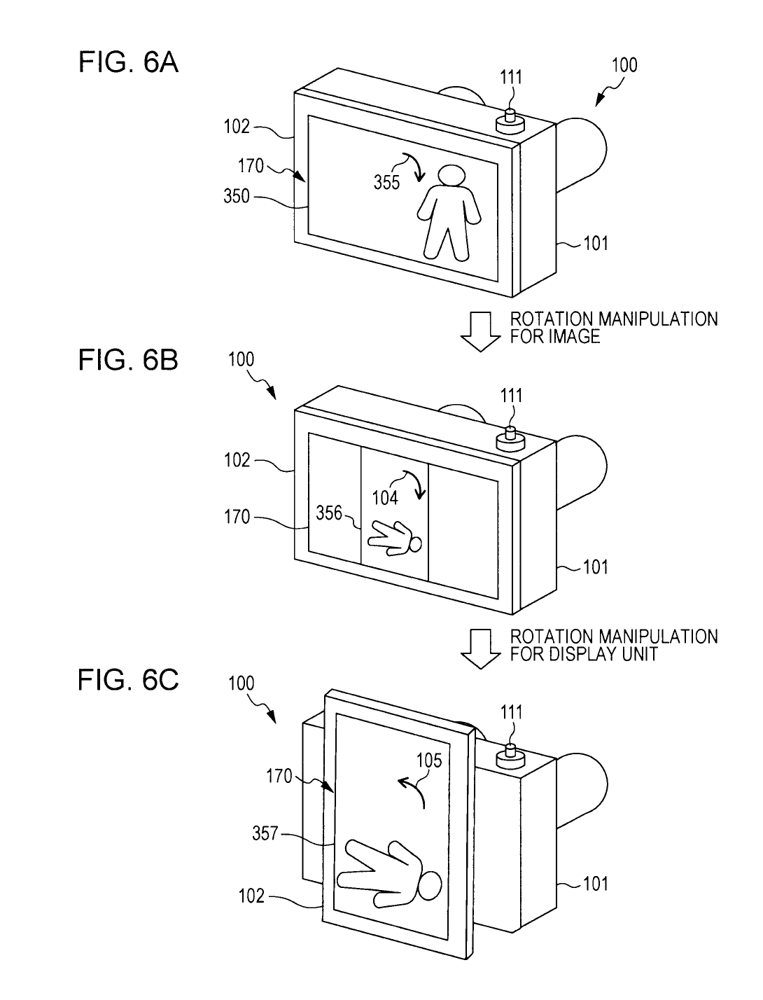

In addition, in the case where the display unit 170 (the second casing 102) is rotated by 90 degrees in the direction of arrow 105 in the state illustrated in FIG. 5B, as illustrated in FIG. 5A, the image 350 is displayed on the display unit 170. In this case, the image processing unit 150 magnifies the image 351 so that the horizontal length of the image 351 illustrated in FIG. 5B is equal to the length of the display area in the horizontal direction of the display unit 170 illustrated in FIG. 5A. Next, the display control unit 160 allows the magnified image 350 to be displayed on the display unit 170. In addition, an example of displaying the image which is rotated by the user manipulation is illustrated in FIGS. 6A to 6C.

In this manner, in the case where the posture of the display unit 170 is changed, the image displayed the display unit 170 is reduced or magnified to be displayed on the display unit 170 according to a change in the posture in the state where the direction of the image displayed the display unit 170 is maintained. In other words, even in the case where the posture of the display unit 170 is changed, the image may be displayed in the state where the direction of the image displayed the display unit 170 is maintained. Therefore, even in the case where the posture of the display unit 170 is changed, before and after the change, the horizontal direction of the user and the horizontal direction of the displayed image may be coincident with each other.

In addition, in the case where the posture of the display unit 170 is changed, the image may be displayed so that the longitudinal direction of the display area of the display unit 170 and the longitudinal direction of the image displayed on the display unit 170 are coincident with each other. In other words, in the case where the display unit 170 (the second casing 102) is rotated by 90 degrees in the direction of arrow 104 in the state illustrated in FIG. 5A, the image 350 is also similarly rotated by 90 degrees in the direction of arrow 104 to be displayed on the display unit 170. Such an aspect of the display may be set by the user manipulation.

### [Example of Display Control According to User Manipulation or Change of Posture of Display Unit]

FIGS. 6A to 6C are diagrams illustrating an example of display control in the case of changing an image displayed on the display unit 170 according to user manipulation from a manipulation receiving unit 110 or a change of a posture of the display unit 170 according to the first embodiment of the present disclosure. FIG. 6A illustrates an example of displaying the image 350 in the case where the display unit 170 is set to be in the horizontally long state. In addition, since the example illustrated in FIG. 6A is the same as that of FIG. 5A, the description thereof is omitted. FIG. 6B illustrates an example of displaying in the case where the image 350 displayed on the display unit 170 is rotated by 90 degrees in the direction of arrow 355 in the above state based on the user manipulation from the manipulation receiving unit 110.

FIG. 6B illustrates an example of displaying an image 356 in the case where the image 350 illustrated in FIG. 6A is rotated by 90 degrees in the direction of arrow 355 based on the user manipulation from the manipulation receiving unit 110. The image 356 is set as a planar image which is obtained by rotating the image 350 illustrated in FIG. 6A to be reduced. More specifically, the image processing unit 150 reduces the image 350 by rotating the image 350 illustrated in FIG. 6A by 90 degrees in the direction of arrow 355 so that the horizontal length of the image 350 is equal to the length of the display area in the horizontal direction of the display unit 170 illustrated in FIG. 6B. Next, the display control unit 160 allows the reduced image 356 to be displayed on the display unit 170. In addition, among the image content stored in the content storage unit 200, with respect to the image content which are subject to the image process of 90-degrees rotation (for example, the image rotated by 90 degrees by the user manipulation after the image recording), similarly, the image after the rotation process is displayed on the display unit 170. FIG. 6C illustrates an example of displaying in the case where the display unit 170 (the second casing 102) is rotated by 90 degrees in the direction of arrow 104 in this state.

FIG. 6C illustrates an example of displaying an image 357 in the case where the display unit 170 is set to be in the vertically long state. The image 357 is set as a planar image which is obtained by magnifying the image 356 illustrated in FIG. 6B. More specifically, the image processing unit 150 magnifies the image 356 so that the horizontal length of the image 356 illustrated in FIG. 6B is equal to the length of the display area in the horizontal direction of the display unit 170 illustrated in FIG. 6C. Next, the display control unit 160 displays the magnified image 357 on the display unit 170.

In addition, in the state illustrated in FIG. 6C, in the case where the display unit 170 (the second casing 102) is rotated by 90 degrees in the direction of arrow 105, as illustrated in FIG. 6B, the image 356 is displayed on the display unit 170. In this case, the image processing unit 150 reduces the image 357 so that the horizontal length of the image 357 illustrated in FIG. 6C is equal to the length of the display area in the horizontal direction of the display unit 170 illustrated in FIG. 6B. Next, the display control unit 160 displays the reduced image 356 on the display unit 170.

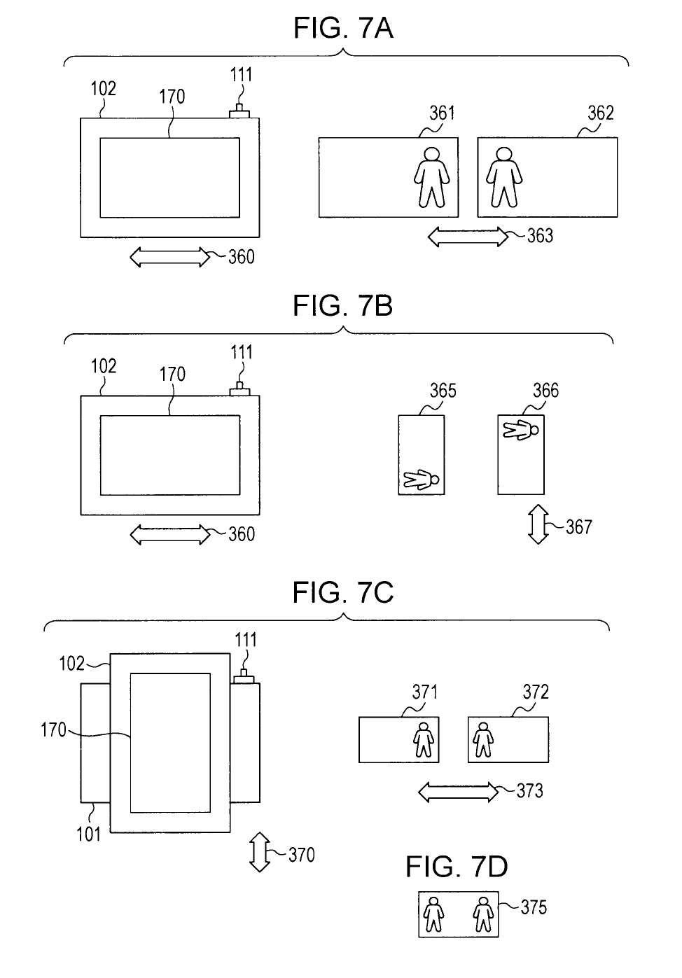

As illustrated in FIGS. 5A and 5B and FIGS. 6A to 6C, the direction of the image displayed on the display unit 170 may be changed according to the user manipulation or a change of the posture of the display unit 170. Herein, a case of change the parallax direction of the stereoscopic image displayed on the display unit 170 according to the user manipulation or a change of the posture of the display unit 170 in the case where the parallax direction of the display unit 170 and the parallax direction of the stereoscopic image displayed on the display unit 170 are coincident with each other is considered. In this case, the parallax direction of the display unit 170 and the parallax direction of the stereoscopic image displayed on the display unit 170 may not be coincident with each other, and thus, the stereoscopic image may not be properly seen. In this manner, examples of the case where the parallax direction of the display unit 170 and the parallax direction of the stereoscopic image displayed on the display unit 170 are not coincident with each other are illustrated in FIGS. 7A to 7D to FIGS. 9A and 9B.

### [Example of Displaying Stereoscopic Image in Case of Fixing Parallax Direction of Display Unit to Longitudinal Direction]

FIGS. 7A to 7D are diagrams illustrating a relationship between the parallax direction of the display unit 170 and the parallax direction of the stereoscopic image displayed on the display unit 170 according to the first embodiment of the present disclosure. In FIGS. 7A to 7D, although the direction of the stereoscopic image is changed according to the user manipulation or a change of the posture of the display unit 170, the case where the parallax direction of the display unit 170 is fixed to the longitudinal direction (directions indicated by arrow 360) is exemplified.

FIG. 7A illustrates an example of displaying a stereoscopic image in the case where the display unit 170 is set to be in the horizontally long state. A left-eye viewing image 361 and a right-eye viewing image 362 are two images which are simultaneously recorded by the image capturing apparatus 100 and the images used for displaying the stereoscopic image by using the parallax direction as the horizontal direction (directions indicated by arrow 363).

As illustrated in FIG. 7A, in the case where the parallax direction (directions indicated by arrow 360) of the display unit 170 and the parallax direction (directions indicated by arrow 363) of the stereoscopic image (the arrow 363 are coincident with each other, the stereoscopic image may be properly seen by the user. However, in the case where the parallax direction of the display unit 170 and the parallax direction of the stereoscopic image are not coincident with each other, the stereoscopic image may not be properly seen by the user. This example is illustrated in FIGS. 7B and 7C.

FIG. 7B illustrates an example of displaying a stereoscopic image in the case where the display unit 170 is set to be in the horizontally long state. This example illustrates the example of displaying the two images (the left-eye viewing image 365 and the right-eye viewing image 366) which are rotated by 90 degrees by the user manipulation at the time of displaying the stereoscopic image or by the user manipulation at the time of recording the stereoscopic image. In addition, the left-eye viewing image 365 and the right-eye viewing image 366 are set as images which are reduced by performing the 90-degrees rotation process on the left-eye viewing image 361 and the right-eye viewing image 362.

As illustrated in FIG. 7B, in the case where the parallax direction (directions indicated by arrow 360) of the display unit 170 and the parallax direction (directions indicated by arrow 367) of the stereoscopic image are not coincident with each other, the stereoscopic image may not be properly seen by the user.

FIG. 7C illustrates an example of displaying a stereoscopic image in the case where the display unit 170 is set to be in the vertically long state. This example illustrates an example of displaying the two images (the left-eye viewing image 371 and the right-eye viewing image 372) to be fitted to the display unit 170 which is considered to be in the vertically long state. In other words, the left-eye viewing image 371 and the right-eye viewing image 372 are set as images which are reduced so that the horizontal lengths of the left-eye viewing image 361 and the right-eye viewing image 362 are equal to the horizontal length of the display unit 170 which is considered to be in the vertically long state.

As illustrated in FIG. 7C, in the case where the parallax direction (directions indicated by arrow 370) of the display unit 170 and the parallax direction (directions indicated by arrow 373) of the stereoscopic image are not coincident with each other, the stereoscopic image may not be properly seen by the user. In addition, in the case where the parallax barrier type is used as a display type for displaying the stereoscopic image on the display unit 170, as illustrated in FIG. 7D, the subject (one person) included in the two images may be seen to be overlapped. In other words, the image 375 illustrated in FIG. 7D may be seen as an image which is composed from the two images (the left-eye viewing image 371 and the right-eye viewing image 372) illustrated in FIG. 7C.

### [Example of Stereoscopic Image in Case of Changing Parallax Direction According to Posture of Display Unit]

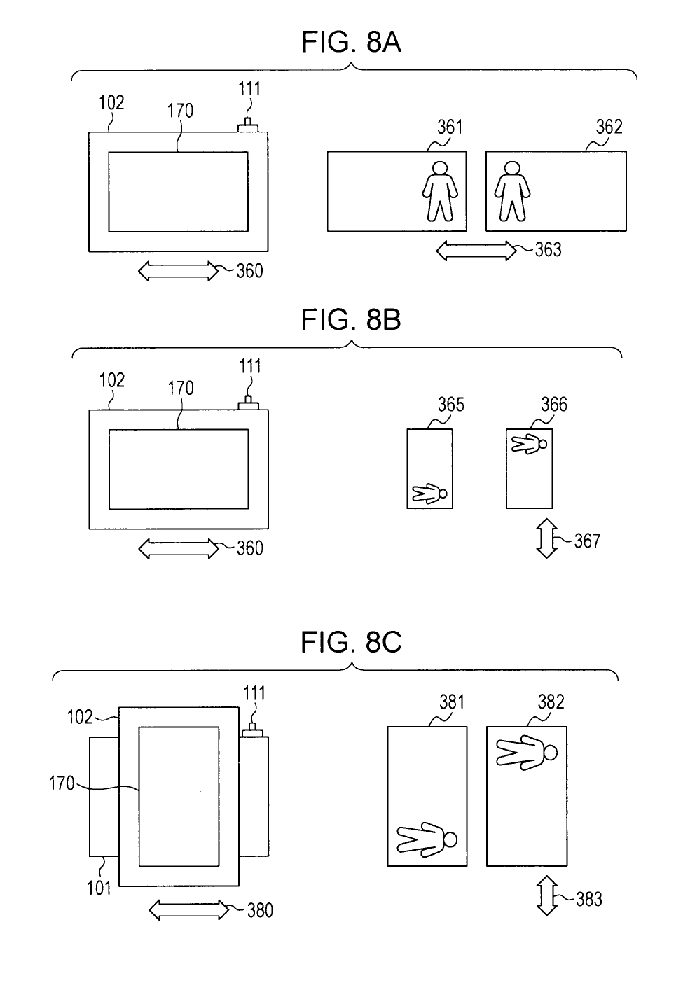

FIGS. 8A to 8C are diagrams illustrating a relationship between the parallax direction of the display unit 170 and the parallax direction of the stereoscopic image displayed on the display unit 170 according to the first embodiment of the present disclosure. FIGS. 8A to 8C illustrates, as an example, the case the direction of the stereoscopic image is not changed according to a change of the posture of the display unit 170 but the parallax direction of the display unit 170 is changed according to the change of the posture of the display unit 170. More specifically, in this example, the horizontal direction (directions indicated by arrow 360) is set as the parallax direction in the case where the display unit 170 is in the horizontally long state; and the vertical direction (directions indicated by arrow 380 of FIG. 8C) is set as the parallax direction in the case where the display unit 170 is in the vertically long state.

FIGS. 8A and 8B illustrate an example of displaying a stereoscopic image in the case where the display unit 170 is set to be in the horizontally long state. Since this example is the same as that of FIGS. 7A and 7B, the description is omitted herein.

FIG. 8C illustrates an example of displaying a stereoscopic image in the case where the display unit 170 is set to be in the vertically long state. This example illustrates an example of displaying the two images (the left-eye viewing image 381 and the right-eye viewing image 382) to be fitted to the display unit 170 which is considered to be in the vertically long state. In other words, the left-eye viewing image 381 and the right-eye viewing image 382 are set as the images which are obtained by rotating the left-eye viewing image 361 and the right-eye viewing image 362 by 90 degrees. In addition, in this example, since the parallax direction of the display unit 170 is changed according to a change of the posture of the display unit 170, the parallax direction (directions indicated by arrow 380) of the display unit 170 is changed.

Therefore, as illustrated in FIG. 8C, the parallax direction (directions indicated by arrow 380) of the display unit 170 and the parallax direction (directions indicated by arrow 383) of the stereoscopic image are not coincident with each other. In this case, the stereoscopic image may not be properly seen by the user.

[Example of Displaying Stereoscopic Image Captured so that Vertical Direction Becomes Parallax Direction]

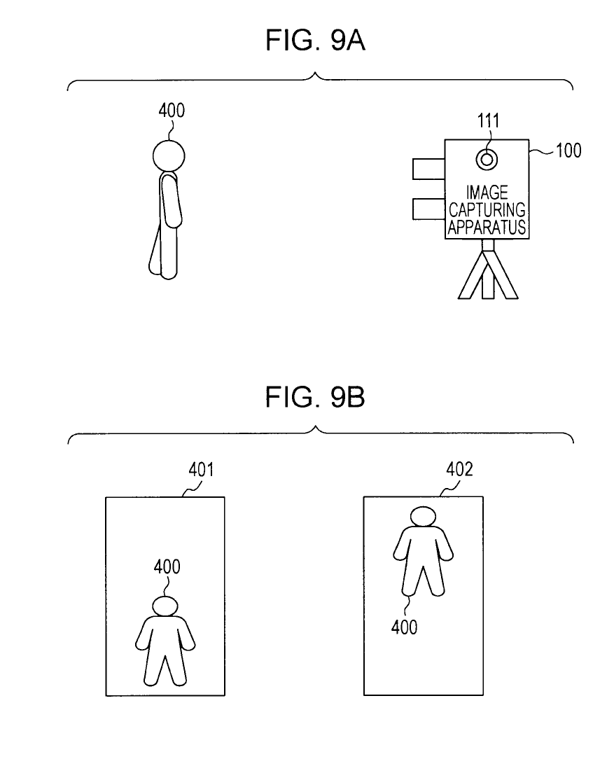

FIGS. 9A and 9B are diagrams illustrating an example of the image capturing operation state performed by using the image capturing apparatus 100 and the stereoscopic image generated through the image capturing operation according to the first embodiment of the present disclosure.

In FIG. 9A, the image capturing operation state performed by using the image capturing apparatus 100 is simplified in the illustration. More specifically, FIG. 9A illustrates the state where a standing person 400 is set as a subject and the image capturing operation is performed by using the image capturing apparatus 100 which is rotated by 90 degree by using the optical axis direction as a rotation axis. In other words, FIG. 9A illustrates the image capturing operation state in the case where the stereoscopic image is captured so that the vertical direction at the time of the image capturing becomes the parallax direction.

FIG. 9B illustrates an example (the left-eye viewing image 401 and the right-eye viewing image 402) of the stereoscopic image generated through the image capturing operation performed by using the image capturing apparatus 100. More specifically, FIG. 9B illustrates the left-eye viewing image 401 generated by the left-eye image capturing unit 210 and the right-eye viewing image 402 generated by the right-eye image capturing unit 220 in the state illustrated in FIG. 9A.

In the state illustrated in FIG. 9A, since the stereoscopic image is captured so that the vertical direction at the time of the image capturing becomes the parallax direction, as illustrated in FIG. 9B, the person 400 included in the left-eye viewing image 401 and the right-eye viewing image 402 is shifted from the longitudinal direction of each image. In this manner, an example of displaying the generated stereoscopic image (the left-eye viewing image 401 and the right-eye viewing image 402) is illustrated in FIGS. 10A to 10C.

FIGS. 10A to 10C are diagrams illustrating a relationship between the parallax direction of the display unit 170 and the parallax direction of the stereoscopic image displayed on the display unit 170 according to the first embodiment of the present disclosure. FIGS. 10A to 100 illustrate an example of displaying the stereoscopic image which is captured so that the vertical direction at the time of the image capturing becomes the parallax direction. In addition, FIGS. 10A to 100 illustrate an example where the direction of the stereoscopic image is not changed according to a change of the posture of the display unit 170 but the parallax direction of the display unit 170 is fixed to the longitudinal direction (directions indicated by arrow 360).

FIG. 10A illustrates the two images (the left-eye viewing image 401 and the right-eye viewing image 402) which are captured so that the vertical direction at the time of the image capturing becomes the parallax direction. The left-eye viewing image 401 and the right-eye viewing image 402 are the same as those illustrated in FIG. 9B.

FIG. 10B illustrates an example of displaying a stereoscopic image in the case where the display unit 170 is set to be in the horizontally long state. This example illustrates an example of displaying the two images (the left-eye viewing image 411 and the right-eye viewing image 412) to be fitted to the display unit 170 which is considered to be in the horizontally long state. In other words, the left-eye viewing image 411 and the right-eye viewing image 412 are set as images which are reduced so that the horizontal lengths of the left-eye viewing image 401 and the right-eye viewing image 402 are equal to the horizontal length of the display unit 170 which is considered to be in the horizontally long state.

As illustrated in FIG. 10B, in the case where the parallax direction (directions indicated by arrow 410) of the display unit 170 and the parallax direction (directions indicated by arrow 413) of the stereoscopic image are not coincident with each other, the stereoscopic image may not be properly seen by the user.

FIG. 10C illustrates an example of displaying a stereoscopic image in the case where the display unit 170 is set to be in the vertically long state. This example illustrates an example of displaying the two images (the left-eye viewing image 421 and the right-eye viewing image 422) to be fitted to the display unit 170 which is considered to be in the vertically long state. In other words, the left-eye viewing image 421 and the right-eye viewing image 422 are set as images of which the sizes are equal to the size of the display unit 170.

As illustrated in FIG. 10C, even in the case where the parallax direction (directions indicated by arrow 420) of the display unit 170 and the parallax direction (directions indicated by arrow 423) of the stereoscopic image are coincident with each other, since the parallax direction becomes the vertical direction, the case where the parallax direction is not coincident with the parallax direction of the person is considered. In other words, in normal cases, since a person may not be seen in this direction, the stereoscopic image may not be properly seen by the user. In addition, although human eyes have tolerance for the shifting in the left and right directions, the human eyes are too sensitive to the shifting in the up and down directions. Therefore, in the case where the shifting in the up and down directions occurs in the stereoscopic image displayed on the display unit 170, it may arouse uncomfortable feelings in the user.

As illustrated in FIGS. 7A to 7D to FIGS. 10A to 10C, in the case where the parallax direction of the display unit 170 and the parallax direction of the stereoscopic image are not coincident with each other, the user may not properly stereoscopically see the stereoscopic image. Therefore, the first embodiment of the present disclosure is configured so that the stereoscopic image may be properly stereoscopically seen by the user even in the case where the parallax direction of the display unit 170 and the parallax direction of the stereoscopic image are not coincident with each other. More specifically, in the case where the parallax direction of the display unit 170 and the parallax direction of the stereoscopic image are not coincident with each other, the direction of the stereoscopic image is changed so that the parallax directions are coincident with each other. Alternatively, in the case where the parallax direction of the display unit 170 and the parallax direction of the stereoscopic image are not coincident with each other, the stereoscopic image which becomes the display object is displayed as a planar image. In addition, which one is preferred may be set by the user manipulation.

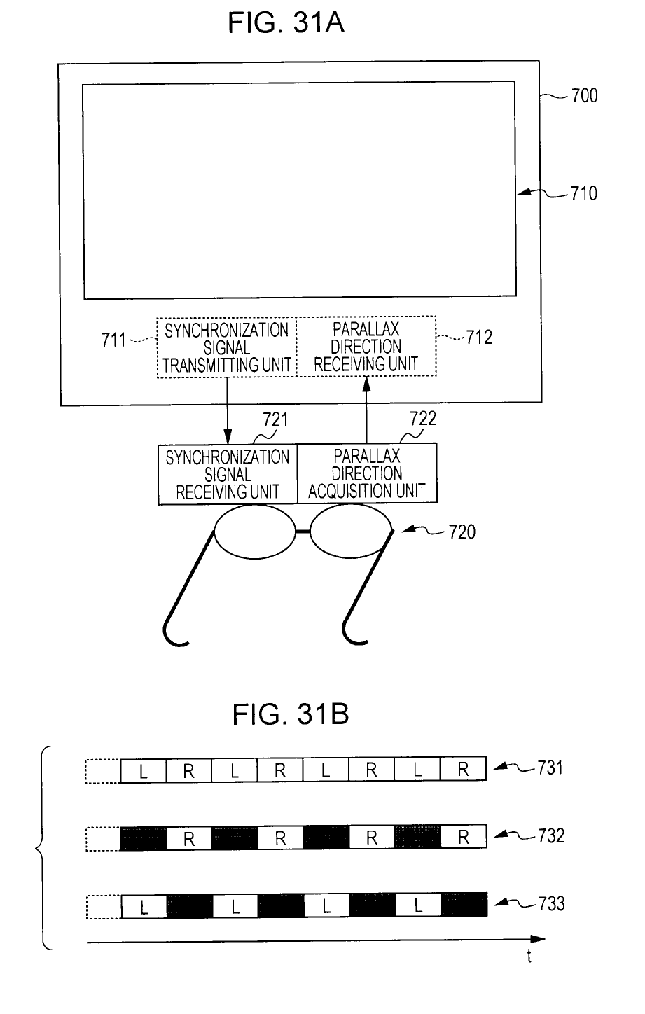

In addition, in the case where the parallax direction of the stereoscopic image displayed on the display unit 170 and the parallax direction of the person are not coincident with each other, the user may not properly stereoscopically see the stereoscopic image. Therefore, the first embodiment of the present disclosure is configured so that the stereoscopic image may be properly stereoscopically seen by the user even in the case where the parallax direction of the stereoscopic image displayed on the display unit 170 and the parallax direction of the person are not coincident with each other. More specifically, in the case where the parallax direction of the stereoscopic image displayed on the display unit 170 and the parallax direction of the person are not coincident with each other, the parallax direction of the display unit 170 is changed so that the parallax directions are coincident with each other. In this case, the parallax direction of the person may be acquired based on, for example, the posture of the display unit 170. In other words, since the parallax direction of the person corresponds to the posture of the display unit 170, the parallax direction of the person may be estimated. For example, the longitudinal direction of the display unit 170 and the parallax direction of the person are estimated to be the same direction. In addition, the parallax direction of the person may be acquired by a parallax direction acquisition unit (for example, a parallax direction acquisition unit 722 of a special-purpose glasses 720 illustrated in FIG. 31A). In addition, in the case where the parallax direction of the stereoscopic image displayed on the display unit 170 and the parallax direction of the person are not coincident with each other, the stereoscopic image which becomes the display object is displayed as a planar image. In addition, which one is preferred may be set by the user manipulation.

### [Example of Display Control in Case of Preferentially Displaying Stereoscopic Image]

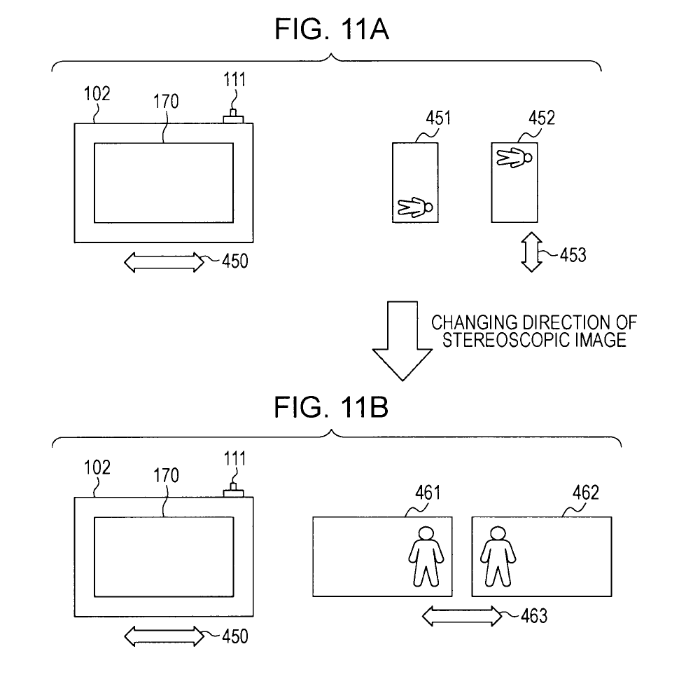

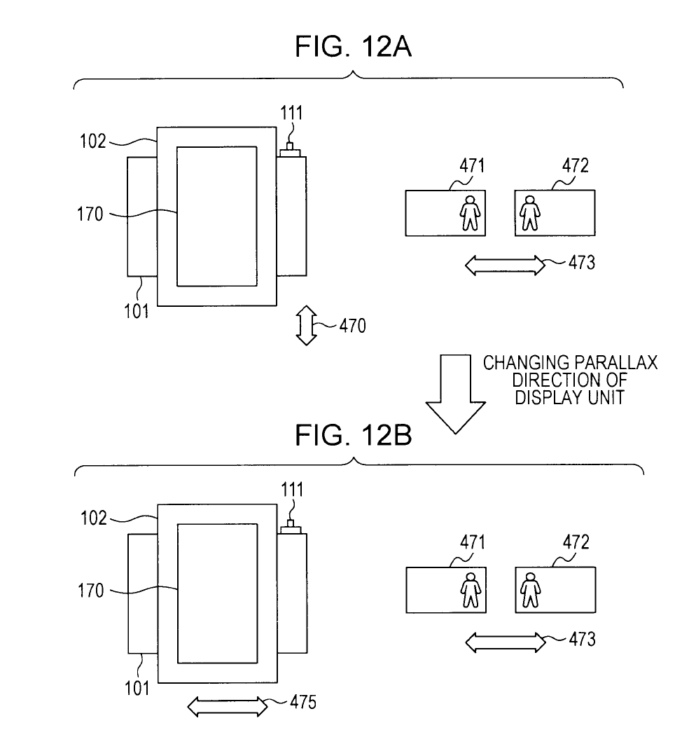

FIGS. 11A and 11B and FIGS. 12A and 12B are schematic diagrams illustrating an example of display control in the case where the parallax direction of the display unit 170 and the parallax direction of the stereoscopic image displayed on the display unit 170 are not coincident with each other according to the first embodiment of the present disclosure. In FIGS. 11A and 11B and FIGS. 12A and 12B, the case where the pressing manipulation of the selection button 332 in the setting screen 330 illustrated in FIG. 4A is performed to set the indication that the displaying of the stereoscopic image is preferred is described as an example. In FIGS. 11A and 11B, in the case where the parallax direction of the display unit 170 and the parallax direction of the stereoscopic image displayed on the display unit 170 are not coincident with each other, an example of changing the direction of the stereoscopic image so that the parallax directions are coincident with each other is illustrated.

FIG. 11A illustrates an example of displaying a stereoscopic image (a left-eye viewing image 451 and a right-eye viewing image 452) in the case where the display unit 170 is set to be in the horizontally long state. This example illustrates an example of displaying the two images (the left-eye viewing image 451 and the right-eye viewing image 452) which are rotated by 90 degrees by the user manipulation at the time of displaying the stereoscopic image or by the user manipulation at the time of recording the stereoscopic image. In addition, the example illustrated in FIG. 11A is the same as that of FIG. 7B.

FIG. 11B illustrates an example of displaying a stereoscopic image (a left-eye viewing image 461 and a right-eye viewing image 462) in the case where the display unit 170 is set to be in the horizontally long state. As illustrated in FIG. 11A, in the case where the parallax direction (directions indicated by arrow 450) of the display unit 170 and the parallax direction (directions indicated by arrow 453) of the stereoscopic image are not coincident with each other, the user may not properly stereoscopically see the stereoscopic image. Therefore, the direction of the stereoscopic image is changed so that the parallax direction of the display unit 170 and the parallax direction of the stereoscopic image are coincident with each other, so that the user may properly stereoscopically see the stereoscopic image.

More specifically, the controller 120 acquires the preference information which is retained in the preference information retention unit 121 and determines the to-be-preferentially-performed control content. In this example, as described above, the preference information which is retained in the preference information retention unit 121 is set to “displaying of stereoscopic image is preferred”. Subsequently, the controller 120 acquires attribute information (attribute information acquired by the attribute information acquisition unit 140) included in the content which becomes a display object and determines whether or not the parallax direction of the display unit 170 and the parallax direction of the stereoscopic image corresponding to the content which becomes the display object are coincident with each other. As a result of the determination, in the case where the parallax direction of the display unit 170 and the parallax direction of the stereoscopic image corresponding to the content which becomes the display object are not coincident with each other, the controller 120 performs display control according to the preference information which is retained in the preference information retention unit 121. In other words, the controller 120 performs control of changing the direction of the stereoscopic image so that the parallax direction of the display unit 170 and the parallax direction of the stereoscopic image are coincident with each other. For example, as illustrated in FIG. 11A, in the case where the parallax direction of the display unit 170 and the parallax direction of the stereoscopic image are not coincident with each other, the image processing unit 150 rotates the stereoscopic image (the left-eye viewing image 451 and the right-eye viewing image 452) by 90 degrees. Subsequently, the image processing unit 150 magnifies the 90-degrees rotated stereoscopic image to be fitted to the size of the display area of the display unit 170. Next, the display control unit 160 allows the magnified stereoscopic image (the left-eye viewing image 461 and the right-eye viewing image 462) to be displayed on the display unit 170. In this manner, by changing the direction of the stereoscopic image which becomes the display object, the user may properly see the stereoscopic image.

In FIGS. 12A and 12B, in the case where the parallax direction of the display unit 170 and the parallax direction of the stereoscopic image displayed on the display unit 170 are not coincident with each other, an example of changing the parallax direction of the display unit 170 so that the parallax directions are coincident with each other illustrated.

FIG. 12A illustrates an example of displaying a stereoscopic image (a left-eye viewing image 471 and a right-eye viewing image 472) in the case where the display unit 170 is set to be in the vertically long state. This example illustrates an example of displaying the two images (the left-eye viewing image 471 and the right-eye viewing image 472) which are rotated by 90 degrees on the 90-degrees rotated display unit 170 by the user manipulation at the time of displaying the stereoscopic image or by the user manipulation at the time of recording the stereoscopic image. In addition, the example illustrated in FIG. 12A is the same as that of FIG. 7C.

FIG. 12B illustrates an example of displaying the stereoscopic image (the left-eye viewing image 471 and the right-eye viewing image 472) in the case where the display unit 170 is set to be in the vertically long state. As illustrated in FIG. 12A, in the case where the parallax direction (directions indicated by arrow 470) of the display unit 170 and the parallax direction (directions indicated by arrow 473) of the stereoscopic image are not coincident with each other, the user may not properly stereoscopically see the stereoscopic image. Therefore, the parallax direction of the display unit 170 is changed so that the parallax direction of the display unit 170 and the parallax direction of the stereoscopic image are coincident with each other, so that the user may properly stereoscopically see the stereoscopic image.

In other words, as illustrated in FIG. 12A, in the case where the parallax direction of the display unit 170 and the parallax direction of the stereoscopic image are not coincident with each other, the controller 120 rotates the parallax direction of the display unit 170 by 90 degrees. In this manner, by changing the parallax direction of the display unit 170, the user may properly see the stereoscopic image.

[Example of Display Control in Case where Direction of Image is Preferred]

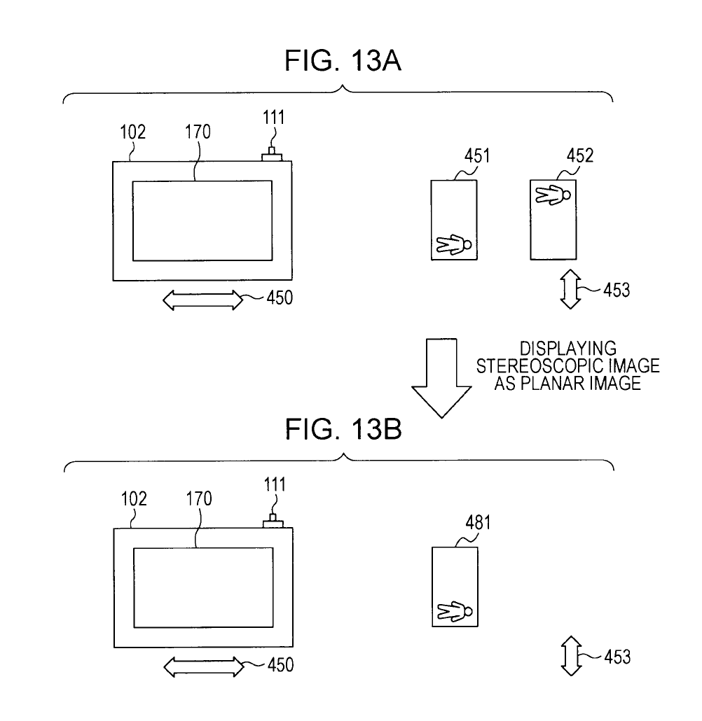

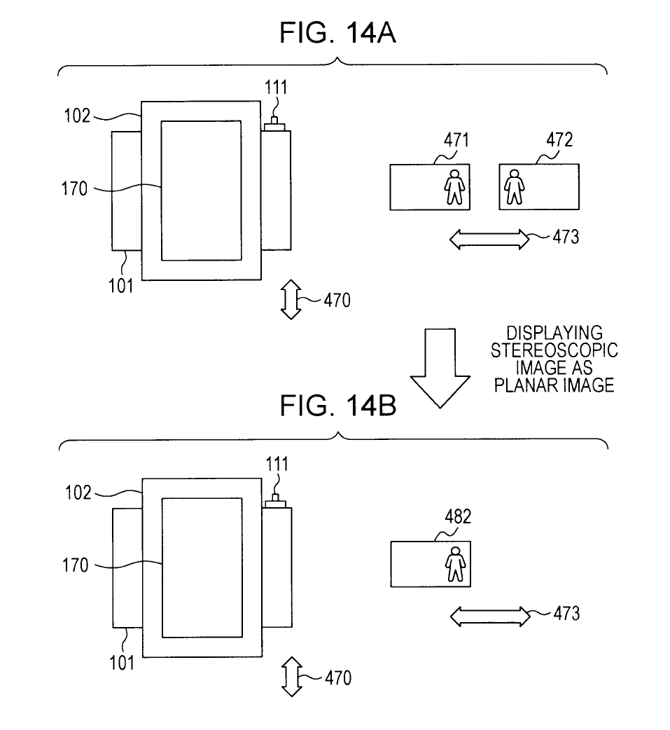

FIGS. 13A and 13B and FIGS. 14A and 14B are schematic diagrams illustrating example of display controls in the case where the parallax direction of the display unit 170 and the parallax direction of the stereoscopic image displayed on the display unit 170 are not coincident with each other according to the first embodiment of the present disclosure. In FIGS. 13A and 13B and FIGS. 14A and 14B, the case where the pressing manipulation of the selection button 331 in the setting screen 330 illustrated in FIG. 4A is performed to set the indication that the direction of the image is preferred is described as an example. In addition, in FIGS. 13A and 13B and FIGS. 14A and 14B, in the case where the parallax direction of the display unit 170 and the parallax direction of the stereoscopic image displayed on the display unit 170 are not coincident with each other, examples of displaying the stereoscopic image as a planar image are illustrated.

FIG. 13A illustrates an example of displaying the stereoscopic image (the left-eye viewing image 451 and the right-eye viewing image 452) in the case where the display unit 170 is set to be in the horizontally long state. In addition, the example illustrated in FIG. 13A is the same as that of FIG. 11A.

FIG. 13B illustrates an example of displaying a planar image (a displayed image 481) in the case where the display unit 170 is set to be in the horizontally long state. As illustrated in FIG. 13A, in the case where the parallax direction (directions indicated by arrow 450) of the display unit 170 and the parallax direction (directions indicated by arrow 453) of the stereoscopic image are not coincident with each other, the user may not properly stereoscopically see the stereoscopic image. Accordingly, the stereoscopic image is displayed as a planar image so that the user may properly see the image in the direction.

In other words, as illustrated in FIG. 13A, in the case where the parallax direction of the display unit 170 and the parallax direction of the stereoscopic image are not coincident with each other, the display control unit 160 displays the stereoscopic image as a planar image 481 on the display unit 170. In this manner, the stereoscopic image is displayed as the planar image 481, so that the user may properly see the image in the desired direction.

FIG. 14A illustrates an example of displaying the stereoscopic image (the left-eye viewing image 471 and the right-eye viewing image 472) in the case where the display unit 170 is set to be in the vertically long state. In addition, the example illustrated in FIG. 14A is the same as that of FIG. 12A.

FIG. 14B illustrates an example of displaying a planar image (a displayed image 482) in the case where the display unit 170 is set to be in the vertically long state. As illustrated in FIG. 14A, in the case where the parallax direction (directions indicated by arrow 470) of the display unit 170 and the parallax direction (directions indicated by arrow 473) of the stereoscopic image are not coincident with each other, the user may not properly stereoscopically see the stereoscopic image. Accordingly, the stereoscopic image is displayed as a planar image so that the user may properly see the image in the direction.

In other words, as illustrated in FIG. 14A, in the case where the parallax direction of the display unit 170 and the parallax direction of the stereoscopic image are not coincident with each other, the display control unit 160 displays the stereoscopic image as a planar image 482 on the display unit 170. In this manner, the stereoscopic image is displayed as the planar image 482, so that the user may properly see the image in the desired direction.

[Example of Displaying Planar Image in Case where Direction is Set to be Preferred]

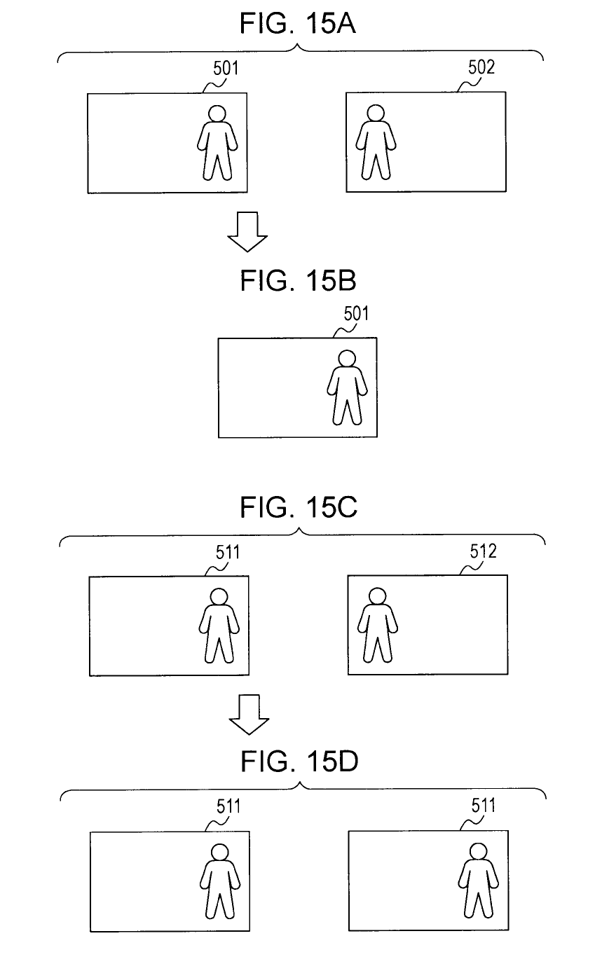

FIGS. 15A to 15D are schematic diagrams illustrating an example of display control in the case of displaying a planar image on the display unit 170 according to the first embodiment of the present disclosure. As illustrated in FIGS. 13A and 13B and FIGS. 14A and 14B, in the case where “the direction of the image is preferred” is set, if the parallax direction of the display unit 170 and the parallax direction of the stereoscopic image are not coincident with each other, the stereoscopic image is displayed as a planar image. Herein, the stereoscopic image is an image (multi-viewing-point image) which is configured by using a plurality of images. For example, in the case of the two-viewing-point image, the stereoscopic image is configured by using two images. Therefore, in the case of displaying the stereoscopic image as a planar image, a displaying method of displaying at least one viewing point image among the plurality of the images (the multi-viewing-point image) constituting the stereoscopic image may be used. Accordingly, an example of this displaying method is illustrated in FIGS. 15A to 15D.

FIGS. 15A and 15B illustrate a displaying method of displaying only one image (one viewing point image) among the plurality of the images (multi-viewing-point image) constituting the stereoscopic image. More specifically, as illustrated in FIG. 15B, the display control unit 160 displays only the left-eye viewing image 501 among the left-eye viewing image 501 and the right-eye viewing image 502 constituting the stereoscopic image but dose not display the right-eye viewing image 502. The displaying method illustrated in FIGS. 15A and 15B is performed, for example, by switching the display mode to the planar image display mode in the case of displaying the stereoscopic image as a planar image and by displaying the left-eye viewing image 501 in the planar image display mode.

FIGS. 15C and 15D illustrate another displaying method of displaying only one image (one viewing point image) among the plurality of the images (multi-viewing-point image) constituting the stereoscopic image. More specifically, as illustrated in FIG. 15D, the display control unit 160 displays the left-eye viewing image 511 among the left-eye viewing image 511 and the right-eye viewing image 512 as the left-eye viewing image and also displays the left-eye viewing image 511 (the right-eye viewing image 511) as the right-eye viewing image. The displaying method illustrated in FIGS. 15C and 15D is performed, for example, by setting the parallax images as the same image in the stereoscopic image display mode.

In this manner, in the first embodiment of the present disclosure, the case where the displaying of the stereoscopic image is set to be preferred and the case where the displaying of the direction of the image is set to be preferred may be easily set by the selection manipulation of the user. For example, in the case where the displaying of the stereoscopic image is set to be preferred, the displaying of the stereoscopic image is preferred to the direction of the stereoscopic image. Therefore, for example, in the case where it is necessary to rotate the stereoscopic image which becomes the display object, the stereoscopic image is displayed after the stereoscopic image is rotated. In addition, in the case where the direction of the image is set to be preferred, the displaying of the stereoscopic image with the direction being preferred is performed only within an available range. Accordingly, it is possible to perform the displaying a proper stereoscopic image according to user's preference.

### [Example of Generation of Vertically Long Stereoscopic Image]

Hereinbefore, the example of mainly displaying the horizontally long stereoscopic image (that is, the stereoscopic image of which the horizontal direction at the time of the image capturing becomes the longitudinal direction) is illustrated. However, a user may be considered to desire that the vertically long stereoscopic image is displayed on the display unit 170 in the vertically long state to be seen. Therefore, hereinafter, an example of generating the stereoscopic image by which the vertically long stereoscopic image may be displayed on the display unit 170 in the vertically long state to be seen is illustrated.

FIGS. 16A to 16D are diagrams illustrating an image generation example in the case of generating the vertically long stereoscopic image by using the image capturing apparatus 100 according to the first embodiment of the present disclosure.

In FIG. 16A, the image capturing operation state performed by using the image capturing apparatus 100 is simplified in the illustration. More specifically, FIG. 16A illustrates the state where a standing person 520 is set as a subject and the image capturing operation is performed by using the image capturing apparatus 100.

FIG. 16B illustrates an example of the stereoscopic image (the left-eye viewing image 521 and the right-eye viewing image 522) generated through the image capturing operation performed by using the image capturing apparatus 100. More specifically, FIG. 16B illustrates the left-eye viewing image 521 generated by the left-eye image capturing unit 210 and the right-eye viewing image 522 generated by the right-eye image capturing unit 220 in the state illustrated in FIG. 16A.

In the state illustrated in FIG. 16A, since the stereoscopic image is captured so that the horizontal direction at the time of the image capturing becomes the parallax direction, as illustrated in FIG. 16B, the person 520 included in the left-eye viewing image 521 and the right-eye viewing image 522 is shifted from the longitudinal direction of each image.

FIGS. 16C and 16D illustrate a flow of generating a vertically long stereoscopic image by using the left-eye viewing image 521 and the right-eye viewing image 522 illustrated in FIG. 16B. More specifically, the captured-image signal processing unit 230 generates a vertically long image 525 by cutting predetermined left and right areas (areas excluding an area surrounded by a bold rectangular line 523) in the left-eye viewing image 521. Similarly, the captured-image signal processing unit 230 a vertically long image 526 by cutting predetermined left and right areas (areas excluding an area surrounded by a bold rectangular line 524) in the right-eye viewing image 522. The recording control unit 260 allows the images 525 and 526, which are generated by cutting a portion of the end portion side of at least one of the two end portions in the longitudinal direction of each of the images in this manner, to be recorded as the left-eye viewing image and the right-eye viewing image in the content storage unit 200. At this time, the image process such as image magnification or image reduction is appropriately performed.

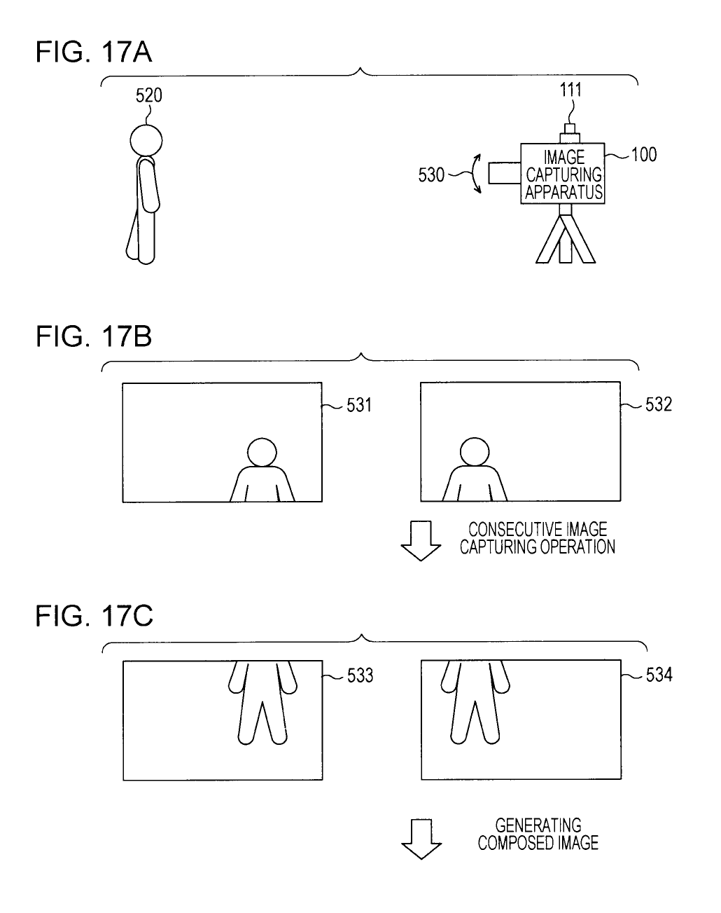

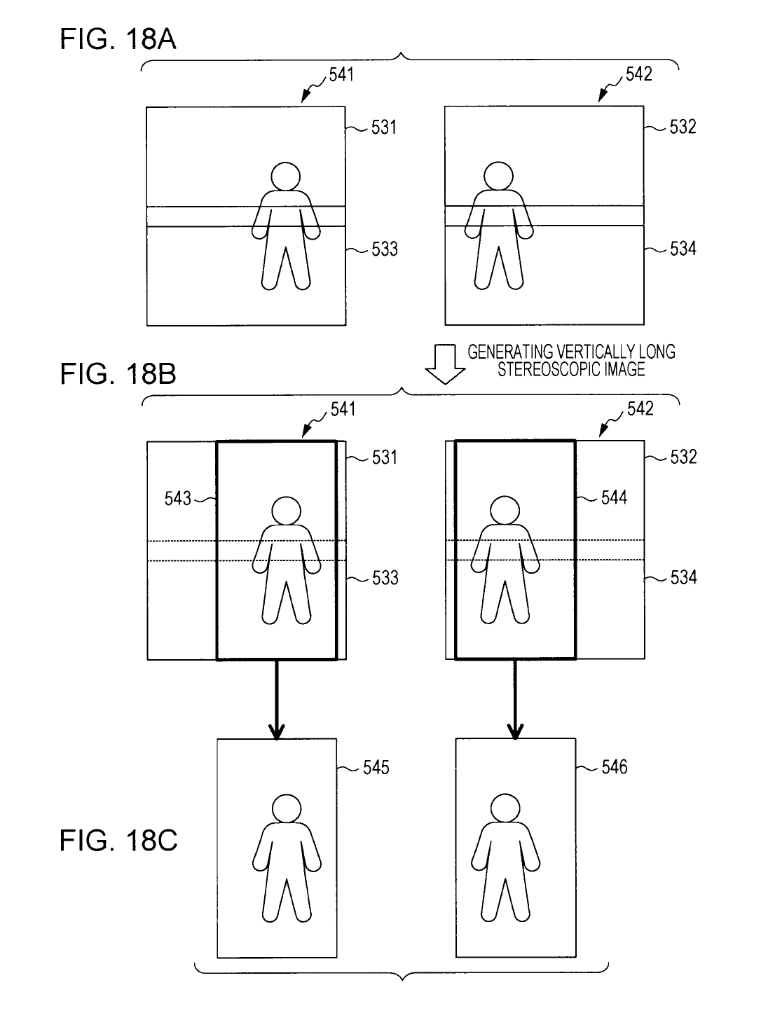

FIGS. 17A to 17C and FIGS. 18A to 18C are diagrams illustrating other image generation examples in the case of generating the vertically long stereoscopic image by using the image capturing apparatus 100 according to the first embodiment of the present disclosure. This example is an example of generating the two images which are consecutively disposed or overlapped in the vertical direction and composing the two generated images to generate the vertically long image.

In FIG. 17A, the image capturing operation state performed by using the image capturing apparatus 100 is simplified in the illustration. In addition, the example illustrated in FIG. 17A is the same as that of FIG. 16A except for the point that arrow 530 is added.

FIGS. 17B and 17C illustrate an example (left-eye viewing images 531 and 533 and right-eye viewing images 532 and 534) of the stereoscopic image generated through the consecutive image capturing operations performed by using the image capturing apparatus 100. More specifically, the left-eye viewing images 531 and 533 and the right-eye viewing images 532 and 534 are generated by performing swing capturing in the state illustrated in FIG. 17A. In other words, the user shakes the image capturing apparatus 100 in the vertical direction (directions indicated by arrow 530), so that the left-eye viewing images 531 and 533 are generated by the left-eye image capturing unit 210 and the right-eye viewing images 532 and 534 are generated by the right-eye image capturing unit 220. In addition, at least a portion of the subjects included in the left-eye viewing images 531 and 533 is set to be overlapped; and at least a portion of the subjects included in the right-eye viewing images 532 and 534 is set to be overlapped.

FIG. 18A illustrates a composed image 541 which is formed by composing the left-eye viewing images 531 and 533 and a composed image 542 which is formed by composing the right-eye viewing images 532 and 534. In this manner, in the case where the two images are composed, the two images are composed to be overlapped based on a correlation between the two images. For example, the movement amount and the movement direction between the two images (that is, the relative displacement between the two images) are detected, the two images are composed based on the detected movement amount and movement direction (the movement amount and the movement direction between the two images) so that the two images are overlapped with each other in the overlapped area. For example, the motion vector (GMV (Global Motion Vector)) corresponding to the motion of the entire image occurring according to the movement of the image capturing apparatus 100 may be detected, and the movement amount and the movement direction may be detected by using the detected motion vector. In addition, the movement amount and the movement direction may be detected based on an angular velocity detected by the image capturing posture detection unit 250.

FIGS. 18B and 18C illustrate a flow of generating a vertically long stereoscopic image by using the composed image 541 and the composed image 542 illustrated in FIG. 18A. More specifically, the captured-image signal processing unit 230 generates a vertically long image 545 by cutting predetermined left and right areas (areas excluding an area surrounded by a bold rectangular line 543) in the composed image 541. Similarly, the captured-image signal processing unit 230 generates a vertically long image 546 by cutting predetermined left and right areas (areas excluding an area surrounded by a bold rectangular line 544) in the composed image 542. The recording control unit 260 allows the images 545 and 546, which are generated by cutting portions of the images in this manner, to be recorded as the left-eye viewing image and the right-eye viewing image in the content storage unit 200. At this time, the image process such as image magnification or image reduction is appropriately performed. In this manner, the left-eye image capturing unit 210 and the right-eye image capturing unit 220 generate a plurality of sets of image groups which are consecutively disposed in time sequence by using the multi-viewing-point images as one set. Next, the captured-image signal processing unit 230 performs composition by using a least a portion of each of the plurality of the generated sets of the image groups to generate a plurality of composed images (the vertically long stereoscopic image) for displaying the stereoscopic image.

In this manner, the vertically long stereoscopic image (the stereoscopic image of which the horizontal direction is the parallax direction) may be generated by using the image capturing apparatus 100.

In addition, although this example illustrates the example of generating the vertically long stereoscopic image by composing the two captured images which are consecutively disposed, the vertically long stereoscopic image may be generating by composing the three captured images or more which are consecutively disposed.

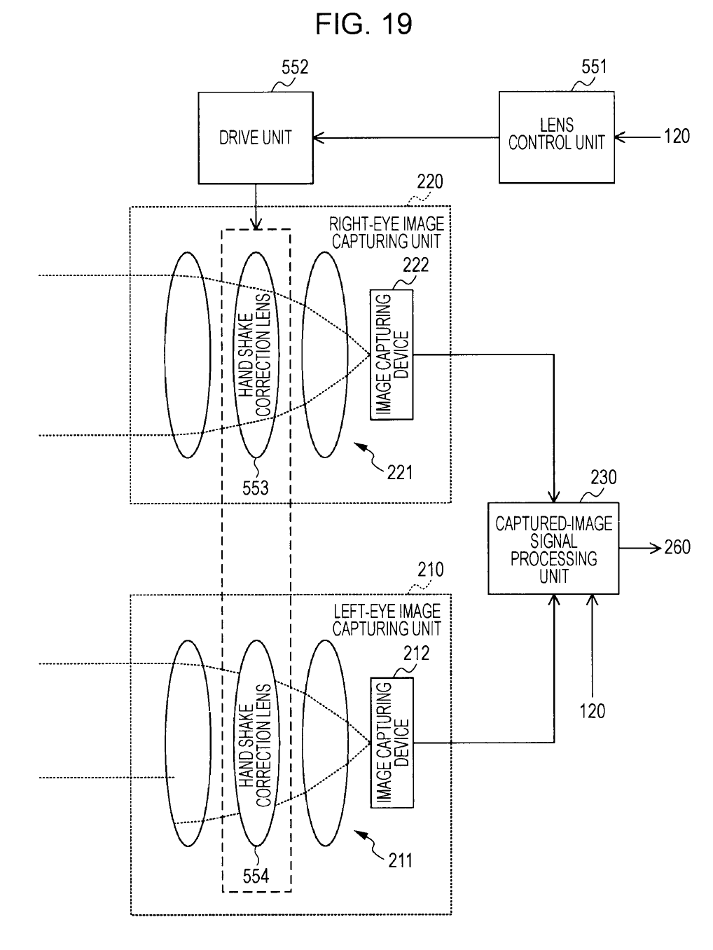

In addition, in the example illustrated in FIGS. 17A to 17C and FIGS. 18A to 18C, an example of generating the two images which are consecutively disposed or overlapped in the vertical direction by the user shaking the image capturing apparatus 100 in the vertical direction is illustrated. However, as illustrated in FIG. 19, a hand shake correction mechanism may be configured to be provided to the image capturing apparatus 100, so that the two images which are consecutively disposed or overlapped in the vertical direction are generated by using the hand shake correction mechanism.

### [Example of Configuration of Hand Shake Correction]

FIG. 19 is a block diagram illustrating an example of functional configuration of the image capturing apparatus 100 according to the first embodiment of the present disclosure. Although FIG. 19 illustrates the example of functional configuration of the case where a hand shake correction mechanism is provide to the image capturing apparatus 100 illustrated in FIG. 2, only a portion of the configuration of the hand shake correction mechanism is illustrated, and the other configurations are omitted in the illustration.

The image capturing apparatus 100 includes a lens control unit 551, a drive unit 552, and a hand shake correction lenses 553 and 554.

The lens control unit 551 is configured to control the hand shake correction lenses 553 and 554 for correcting hand shake correction based on the control of the controller 120. The drive unit 552 is configured to move the hand shake correction lenses 553 and 554 based on the control of the lens control unit 551, so that the hand shake correction is performed.

Herein, the case of generating the two images, which are consecutively disposed or overlapped in the vertical direction, by using the image capturing apparatus 100 having the hand shake correction mechanism is described. For example, in the case where a subject of interest (for example, a person) is located at a position which is relatively far from the image capturing apparatus 100, the two images (the two images which are consecutively disposed or overlapped) where the subject of interest in the vertical direction is shifted may be generated by using the hand shake correction mechanism.

In addition, the user shakes the image capturing apparatus 100 having the hand shake correction mechanism in the vertical direction to generate the two images which are consecutively disposed or overlapped in the vertical direction, so that the shifting due to the shaking may be corrected by using the hand shake correction mechanism.

### [Example of Displaying Vertically Long Stereoscopic Image]

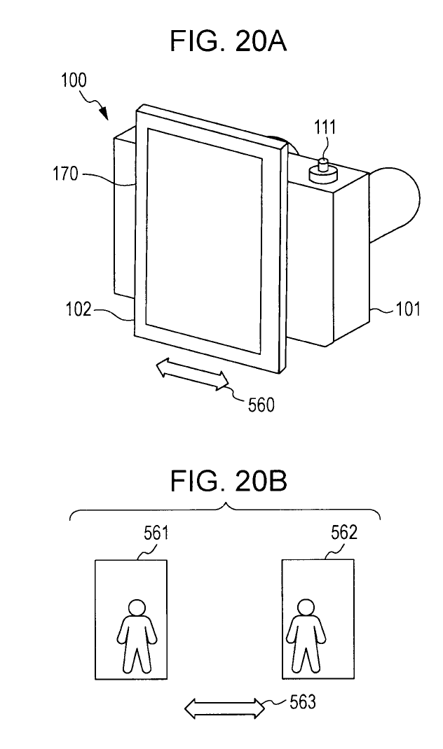

As described hereinbefore, in the case of displaying the vertically long stereoscopic image (stereoscopic image of which the horizontal direction is the parallax direction) generated by the image capturing apparatus 100, an example of displaying the vertically long stereoscopic image is illustrated FIGS. 20A and 20B.

FIGS. 20A and 20B are diagrams illustrating a relationship between the parallax direction of the display unit 170 and the parallax direction of the stereoscopic image displayed on the display unit 170 according to the first embodiment of the present disclosure. FIG. 20A illustrates outer appearance of the image capturing apparatus 100 in the case where the display unit 170 is in the vertically long state. In addition, FIGS. 20A and 20B illustrates the case where the parallax direction of the display unit 170 is changed according to a change of the posture of the display unit 170 as an example. More specifically, an example where the horizontal direction (directions indicated by arrow 560) is set to the parallax direction in the case where the display unit 170 is in the vertically long state is illustrated.

FIG. 20B illustrates an example of displaying a stereoscopic image in the case where the display unit 170 is set to be in the vertically long state. A left-eye viewing image 561 and a right-eye viewing image 562 are the two images generated by the generating method illustrated in FIGS. 16A to 16D to FIGS. 18A to 18C and the images for displaying the stereoscopic image by setting the parallax direction to the horizontal direction (directions indicated by arrow 563).

As illustrated in FIGS. 20A and 20B, the stereoscopic image which becomes the display object is a vertically long image and the parallax direction is the horizontal direction. However, the parallax direction (directions indicated by arrow 560) of the display unit 170 and the parallax direction (directions indicated by arrow 563) of the stereoscopic image are coincident with each other. Therefore, the vertically long stereoscopic image may be properly seen by the user.

In this manner, the vertically long stereoscopic image may be generated and recorded through the image process at the time of the image capturing. In addition, the vertically long stereoscopic image may be generated and displayed by performing the aforementioned image process on the horizontally long stereoscopic image at the time of displaying the stereoscopic image.

Hereinbefore, the example of generating the vertically long stereoscopic image by performing the composing process or the cutting process on the left-eye viewing image and the right-eye viewing image which constitute the horizontally long stereoscopic image is described. Hereinafter, an example of changing the parallax direction of the stereoscopic image by generating new images based on shift amounts of the images which constitute the stereoscopic image is described.

### [Example of Changing Parallax Direction of Stereoscopic Image]

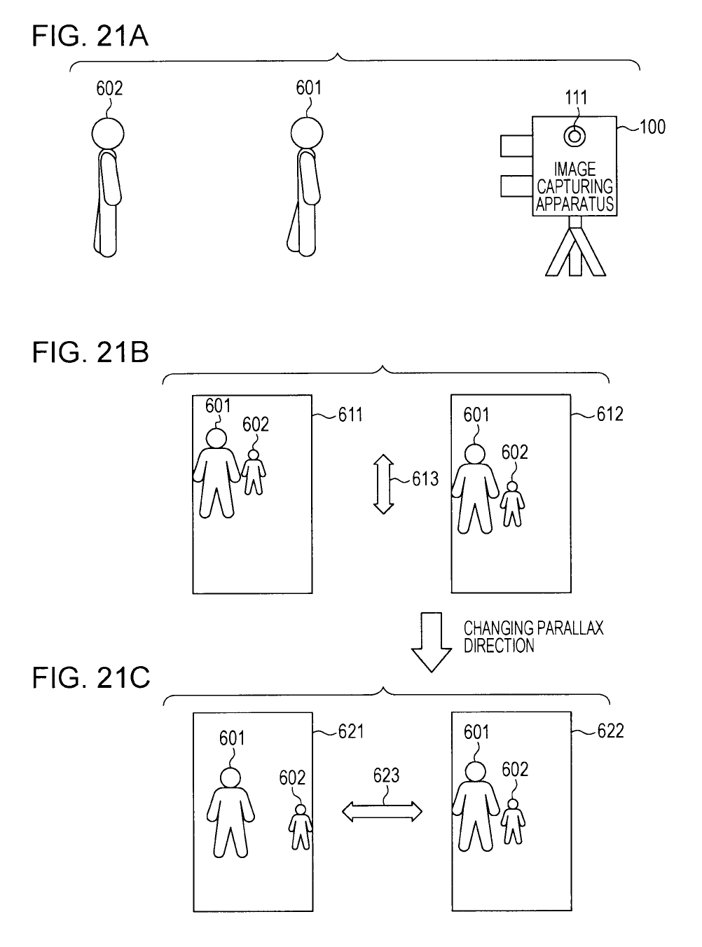

FIGS. 21A to 21C are schematic diagrams illustrating an image capturing operation state performed by using the image capturing apparatus 100 and a flow in the case of changing the parallax direction of the stereoscopic image according to the first embodiment of the present disclosure. This example illustrates a changing method where the image is divided into a plurality of areas and the parallax direction of the stereoscopic image is changed by using motion vectors in the divided areas. In addition, in this example, a block matching method is used as a detection method of detecting the motion vectors which are used for changing the parallax direction of the stereoscopic image. The block matching method is a method of searching which portion of the other image as an object of comparison an image which is similar to the image included in the object areas as objects of detection of motion vectors is located at and detecting the motion vectors of blocks of the object image based on a result of the searching. More specifically, the object image is divided into a plurality of areas (blocks); a searching range is set to be the size of an assumed maximum motion amount with respect to the divided areas of the object image; and the searching is performed within the set searching range, so that the motion vectors are detected.

In FIG. 21A, the image capturing operation state performed by using the image capturing apparatus 100 is simplified in the illustration. More specifically, FIG. 21A illustrates the state where standing persons 601 and 602 are set as a subject and the image capturing operation is performed by using the image capturing apparatus 100 which is rotated by 90 degree by using the optical axis direction as a rotation axis. In other words, FIG. 21A illustrates the image capturing operation state in the case where the stereoscopic image is captured so that the vertical direction at the time of the image capturing becomes the parallax direction.

In FIG. 21B, the stereoscopic image (the left-eye viewing image 611 and the right-eye viewing image 612) generated by the image capturing apparatus 100 in the state illustrated in FIG. 21A is simplified in the illustration. The left-eye viewing image 611 and the right-eye viewing image 612 are images which are captured by the image capturing apparatus 100 which is rotated by 90 degrees by using the optical axis direction as a rotation center, and the subjects 601 and 602 included in the left-eye viewing image 611 and the right-eye viewing image 612 are shifted in the vertical direction. In other words, the parallax directions of the left-eye viewing image 611 and the right-eye viewing image 612 are the vertical direction (directions indicated by arrow 613).

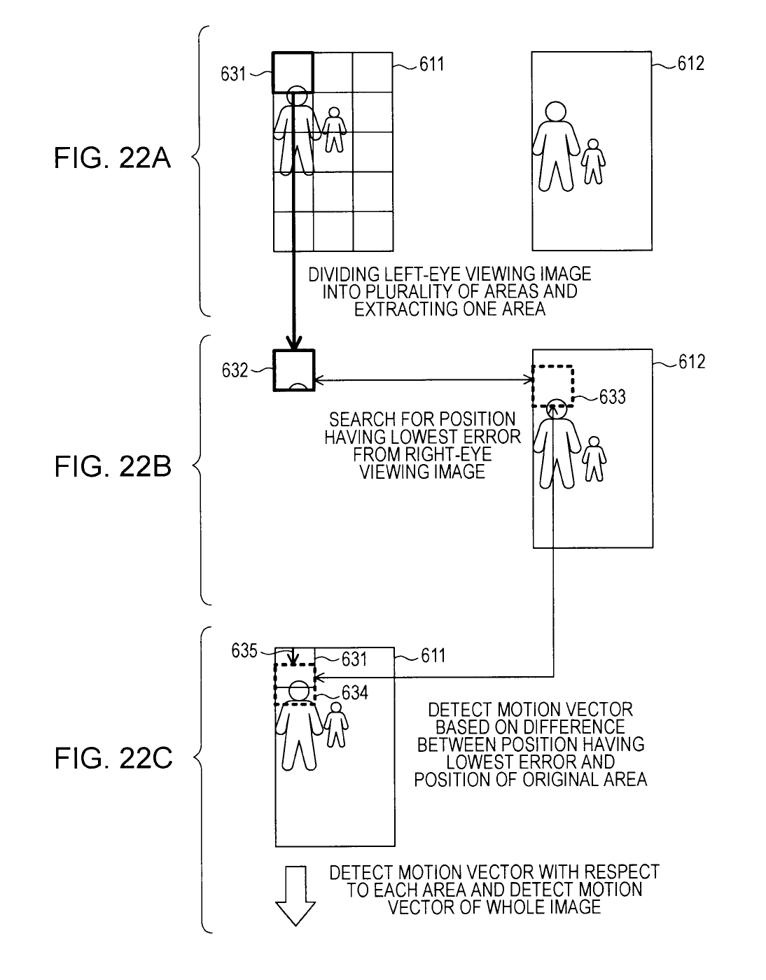

In FIG. 21C, the stereoscopic image (the left-eye viewing image 621 and the right-eye viewing image 622) generated by changing the parallax direction with respect to the stereoscopic image (the left-eye viewing image 611 and the right-eye viewing image 612) illustrated in FIG. 21B is simplified in the illustration. Since the parallax directions of the left-eye viewing image 621 and the right-eye viewing image 622 are changed, the subjects 601 and 602 included in the left-eye viewing image 621 and the right-eye viewing image 622 are shifted in the horizontal direction. In other words, the parallax directions of the left-eye viewing image 621 and the right-eye viewing image 622 are the horizontal direction (directions indicated by arrow 623). In addition, the right-eye viewing image 622 is the same as the right-eye viewing image 612 illustrated in FIG. 21B. In addition, a method of changing the parallax direction of the stereoscopic image will be described in detail with reference to FIGS. 22A to 22C to FIGS. 24A and 24B.

FIGS. 22A to 22C to FIGS. 24A and 24B are schematic diagrams illustrating a flow in the case of changing the parallax direction of the stereoscopic image by the captured-image signal processing unit 230 according to the first embodiment of the present disclosure.

In FIG. 22A, the stereoscopic image (the left-eye viewing image 611 and the right-eye viewing image 612) generated by the image capturing apparatus 100 is simplified in the illustration. In addition, the left-eye viewing image 611 and the right-eye viewing image 612 are the same as those of FIG. 21B except that the reference numerals 601 and 602 are omitted. In addition, FIG. 22A illustrates an example of division in the case where the left-eye viewing image 611 is divided into a plurality of areas. In addition, in the example illustrated in FIG. 22A, for convenience of the description, the sizes of the divided areas are illustrated to be relatively enlarged. In addition, the area 631 at the left upper corner of the left-eye viewing image 611 is indicated by a bold rectangle line.

FIG. 22B illustrates a relation between an image 632 included the area 631 extracted as an object of comparison from the divided areas of the left-eye viewing image 611 and an area 633 having highest correlation with the image 632 in the right-eye viewing image 612.

FIG. 22C illustrates an example of detection of the motion vectors based on the area 633 having highest correlation with the image 632 in the right-eye viewing image 612.

As illustrated in FIG. 22B, the area 631 as an object of comparison is extracted from the divided areas of the left-eye viewing image 611. Next, in the searching range set as the right-eye viewing image 612, the image 632 included in the extracted area 631 is moved to detect the area having the highest correlation with the image 632. For example, the area having the highest correlation with the image 632 in the right-eye viewing image 612 is set as the area 633 (indicated by a rectangular dotted line). Next, as a result of the searching, in the case where the area having the highest correlation with the image 632 included in the area 631 is detected in the searching range, the motion vector 635 is obtained based on the positional relation between the area 631 and the area 633.

In other words, as illustrated in FIG. 22C, the motion vectors 635 are obtained based on the movement direction and the movement amount of the area 631 and the area 634 (the area (indicated by a rectangular bold dotted line) at the position corresponding to the area 633 in the right-eye viewing image 612) in the left-eye viewing image 611. In addition, with respect the divided areas of the left-eye viewing image 611, the processes of FIGS. 22A to 22C are repetitively performed, so that the motion vectors are obtained from the areas.

In this manner, in the block matching method, one motion vector is calculated with respect to one object area. In other words, a correlation determination (matching determination) process between the images is performed in units of the divided block, so that the motion vector of each block is obtained.

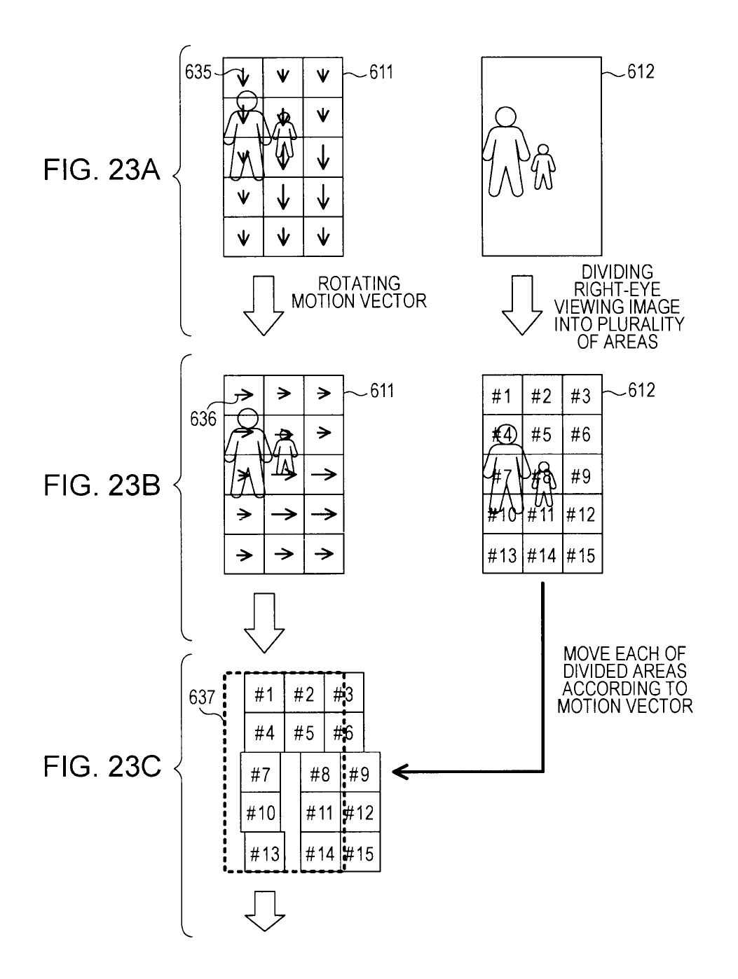

FIG. 23A schematically illustrates motion vectors detected from the areas of the left-eye viewing image 611. The motion vectors are detected from the areas of the left-eye viewing image 611 by using the aforementioned motion vector detection method. In FIG. 23A, the detected the motion vectors in the left-eye viewing image 611 are indicated by arrows in the corresponding areas. In addition, the right-eye viewing image 612 as a comparison object and the left-eye viewing image 611 attached with the arrows indicating the motion vectors are illustrated to be arranged side by side.

FIG. 23B schematically illustrates motion vectors obtained by rotating the motion vectors of the areas illustrated in FIG. 23A by 90 degrees clockwise. For example, the motion vectors 635 are rotated by 90 degrees clockwise, so that the motion vectors 636 are obtained. In addition, FIG. 23B illustrates an example of division in the case where the right-eye viewing image 612 is divided into a plurality of areas. In this division, the right-eye viewing image 612 is divided into the areas of which the size is equal to the size of each of the divided areas of the left-eye viewing image 611. In addition, in FIG. 23B, the divided areas are indicated by allocating identification numbers (#1 to #15).

FIG. 23C illustrates an example of arrangement of the areas in the case where the areas (#1 to #15) of the right-eye viewing image 612 are moved based on the motion vectors illustrated in FIG. 23B. In addition, in FIG. 23C, the areas of the left-eye viewing image after the parallax direction thereof is changed are indicated by rectangular dotted lines 637.

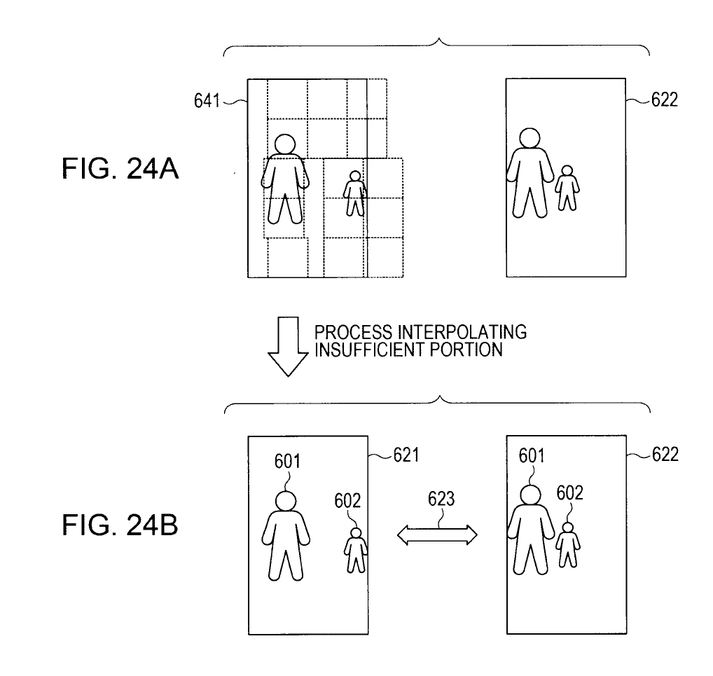

In FIG. 24A, in the case where the areas (#1 to #15) of the right-eye viewing image 612 are moved as illustrated in FIG. 23C, the images included in the areas are simplified in the illustration. In addition, the arrangement of the areas illustrated in FIG. 24A is the same as the arrangement illustrated in FIG. 23C. In addition, in FIG. 24A, the identification numbers (#1 to #15) attached to the areas are omitted, and the rectangles corresponding to the areas are indicated by dotted lines.

As illustrated in FIG. 23C and FIG. 24A, the areas (#1 to #15) of the right-eye viewing image 612 are moved based on the motion vectors detected with respect to the areas in the left-eye viewing image 611. In this manner, the left-eye viewing image 641 of which the parallax direction is changed may be generated by moving the areas. In addition, as illustrated in FIG. 23C and FIG. 24A, in the case where the areas (#1 to #15) of the right-eye viewing image 612 are moved, areas (gap areas) where there is no image information occur in the areas of the left-eye viewing image after the parallax direction thereof is changed. In this manner, the captured-image signal processing unit 230 performs an interpolation process on the occurring gap areas. For example, in the case where the stereoscopic image of which the parallax direction is the object of the changing is a moving image, the interpolation process or the averaging process in the time axis or the spatial axis may be performed. For example, with respect to the gap area, the time interpolation may be performed by using the images in the vicinity (the vicinity of the gap areas) included in the adjacent or neighboring frames within a predetermined range in the time axis. In addition, with respect to the gap area, in the case where an appropriate image does not exist in the vicinity (the vicinity of the gap areas) included in the adjacent or neighboring frames within a predetermined range in the time axis, the spatial interpolation may be performed in the screen of the captured image which is the object of the interpolation. In addition, for example, in the case where the stereoscopic image of which the parallax direction is the object of the changing is a still image, the interpolation process or the averaging process in the spatial axis may be performed.

In FIG. 24B, the stereoscopic image (the left-eye viewing image 621 and the right-eye viewing image 622) generated by changing the parallax direction with respect to the stereoscopic image (the left-eye viewing image 611 and the right-eye viewing image 612) illustrated in FIG. 21B is simplified in the illustration. In addition, the stereoscopic image (the left-eye viewing image 621 and the right-eye viewing image 622) illustrated in FIG. 24B is the same as that of FIG. 21C. In addition, the left-eye viewing image 621 is an image generated by moving each of the areas (#1 to #15) of the right-eye viewing image 612 and, after that, performing the interpolation process.

In this manner, the left-eye image capturing unit 210 and the right-eye image capturing unit 220 generates the left-eye viewing image and the right-eye viewing image. Subsequently, the captured-image signal processing unit 230 detects the movement amount and the movement direction of each of the plurality of areas of the left-eye viewing image with respect to the right-eye viewing image based on the generated left-eye viewing image and the generated right-eye viewing image. Subsequently, the captured-image signal processing unit 230 moves the images of the plurality of areas of the right-eye viewing image based on the detected movement amount and the detected movement direction of each of the areas of the left-eye viewing image and generates a composed image (new left-eye viewing image) based on the after-movement images.

In this manner, the vertically long stereoscopic image of which the horizontal direction becomes the parallax direction may be generated and recorded by changing the parallax direction through the image process at the time of the image capturing. In addition, the vertically long stereoscopic image of which the horizontal direction becomes the parallax direction may be generated and displayed by performing the aforementioned image process on the vertically long stereoscopic image of which the vertical direction becomes the parallax direction at the time of displaying the stereoscopic image.

In addition, in the case of generating the vertically long stereoscopic image through the composing process or the cutting process or the case of generating the vertically long stereoscopic image through the parallax direction changing process, the before-process stereoscopic images and the after-process stereoscopic images may be recorded in a correspondence manner. Accordingly, the before-process stereoscopic image and the after-process stereoscopic image may be used at the time of displaying.

### [Example of Operations of Image Capturing Apparatus]

Next, operations of the image capturing apparatus 100 according to the first embodiment of the present disclosure are described with reference the drawings.

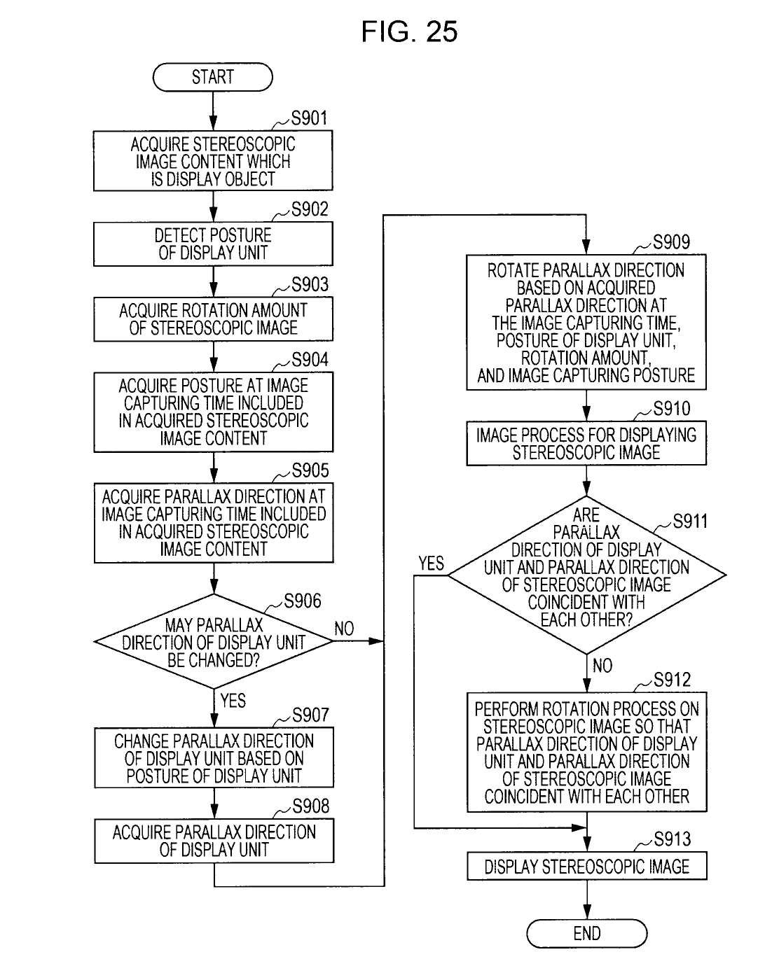

FIG. 25 is a flowchart illustrating an example of a process procedure of an image display control process of the image capturing apparatus 100 according to the first embodiment of the present disclosure. In this example, in the case where the parallax direction of the stereoscopic image and the parallax direction of the display unit 170 are not coincident with each other, an example of performing an image process on the stereoscopic image and displaying the stereoscopic image, which is subject to the image process, on the display unit 170 so that the parallax direction are coincident with each other is illustrated. In addition, this example illustrates the image display control process at the time of performing display command manipulation of a still image in the state where a still image display mode is set.

First, the content acquisition unit 130 acquires image content, which become display object, from the content storage unit 200 (Step S901). In addition, Step S901 is an example of an acquisition procedure disclosed in the embodiments of the present disclosure. Subsequently, the posture-of-display-unit detection unit 180 detects a posture of the display unit 170 (Step S902), and the controller 120 acquires a result of the detection. Subsequently, the controller 120 acquires the rotation amount (the rotation amount of the stereoscopic image) according to the rotation command manipulation received by the manipulation receiving unit 110 (Step S903). Subsequently, the attribute information acquisition unit 140 acquires the posture (the image capturing posture) at the time of the image capturing included in the image content acquired by the content acquisition unit 130 (Step S904), so that the controller 120 acquires the image capturing posture. Subsequently, the attribute information acquisition unit 140 acquires the parallax direction (the image-capturing-time parallax direction) at the time of the image capturing included in the image content acquired by the content acquisition unit 130 (Step S905), so that the controller 120 acquires the image-capturing-time parallax direction.

Subsequently, it is determined based on the posture of the display unit 170 whether or not the changing of the parallax direction of the display unit 170 is set (Step S906). In the case where the changing of the parallax direction of the display unit 170 is set (Step S906), the controller 120 changes the parallax direction of the display unit 170 based on the posture of the display unit 170 (Step S907), so that the changed parallax direction is acquired (Step S908). For example, in the case where the display unit 170 (the second casing 102) is changed from the horizontally long state to the vertically long state, the changing of the parallax direction of the display unit 170 is performed. For example, the parallax direction illustrated in FIG. 3B is changed into the parallax direction illustrated in FIG. 3C. In addition, in the case where it is not necessary to change the parallax direction of the display unit 170, the changing of the parallax direction is not performed. In addition, in the case where the changing of the parallax direction of the display unit 170 is not set (Step S906), the procedure proceeds to Step S909.

Subsequently, the controller 120 performs the rotation process on the parallax direction of the stereoscopic image based on the acquired image-capturing-time parallax direction, the posture of the display unit 170, the rotation amount of the stereoscopic image, and the image capturing posture (Step S909). In other words, similarly to the rotation process for the stereoscopic image, the rotation process for the parallax direction of the stereoscopic image is performed according to the setting content with respect to the displaying, which are set by the user.

Subsequently, the image processing unit 150 performs the image process for displaying the stereoscopic image corresponding to the image content acquired by the content acquisition unit 130 based on the control of the controller 120 (Step S910). In this case, the rotation process is performed on the stereoscopic image based on the acquired image-capturing-time parallax direction, the posture of the display unit 170, the rotation amount of the stereoscopic image, and the image capturing posture.

Subsequently, it is determined whether or not the parallax direction of the stereoscopic image displayed on the display unit 170 and the parallax direction of the display unit 170 are coincident with each other (Step S911). Next, if the parallax directions are coincident with each other (Step S911), the stereoscopic image which is subject to the image process for display is allowed to be displayed on the display unit 170 (Step S913). On the other hand, if the parallax direction of the stereoscopic image displayed on the display unit 170 and the parallax direction of the display unit 170 are not coincident with each other (Step S911), the image process (rotation process) is performed on the stereoscopic image so that the parallax directions are coincident with each other (Step S912). Next, the stereoscopic image, which is subject to the image process, is allowed to be displayed on the display unit 170 (Step S913).

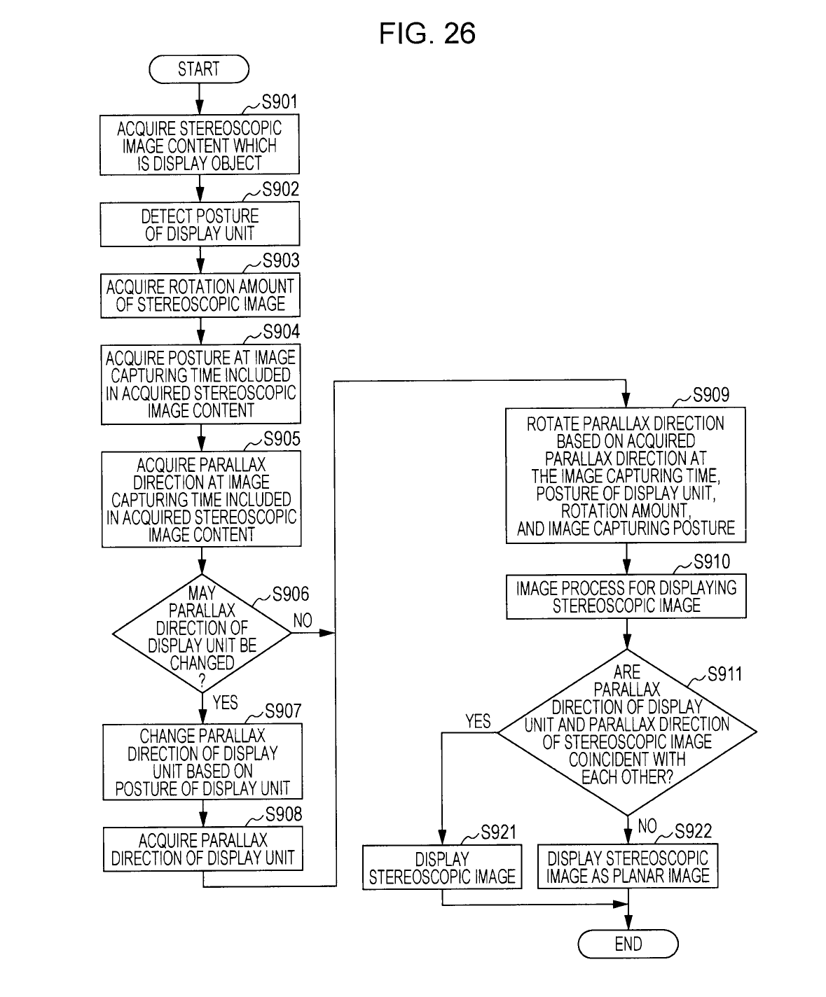

FIG. 26 is a flowchart illustrating an example of a process procedure of the image display control process of the image capturing apparatus 100 according to the first embodiment of the present disclosure. In this example, in the case where the parallax direction of the stereoscopic image and the parallax direction of the display unit 170 are not coincident with each other, an example of display the stereoscopic image as a planar image on the display unit 170 is illustrated. In addition, this example illustrates the image display control process of the time of performing the display command manipulation of the still image in the state where the still image display mode is set. In addition, the process procedure is a modified example of the process procedure illustrated in FIG. 25. Therefore, the same portions as the process procedure illustrated in FIG. 25 are denoted by the same reference numerals, and the description of the same portions is omitted.

It is determined whether or no the parallax direction of the stereoscopic image displayed on the display unit 170 and the parallax direction of the display unit 170 are coincident with each other (Step S911). Next, if the parallax directions are coincident with each other (Step S911), the stereoscopic image which is subject to the image process for display is allowed to be displayed on the display unit 170 (Step S921). On the other hand, if the parallax direction of the stereoscopic image displayed on the display unit 170 and the parallax direction of the display unit 170 are not coincident with each other (Step S911), the stereoscopic image is allowed to be displayed as a planar image on the display unit 170 (Step S922).

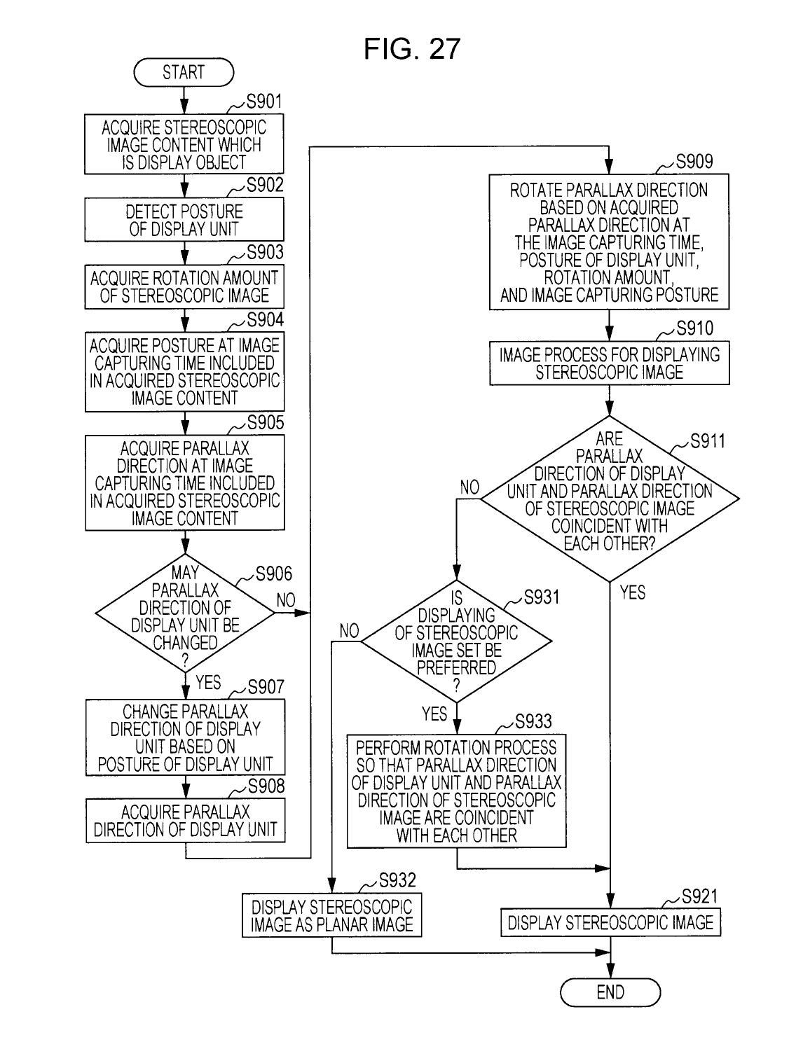

FIG. 27 is a flowchart illustrating an example of a process procedure of the image display control process of the image capturing apparatus 100 according to the first embodiment of the present disclosure. This example illustrates an example of determining based on the preference information according to the user setting whether the stereoscopic image is displayed as a planar image or the stereoscopic image is displayed after the image process in the case where the parallax direction of the stereoscopic image and the parallax direction of the display unit 170 are not coincident with each other. In addition, this example illustrates the image display control process of the time of performing the display command manipulation of the still image in the state where the still image display mode is set. In addition, the process procedure is a modified example of the process procedure illustrated in FIG. 25. Therefore, the same portions as the process procedure illustrated in FIG. 25 are denoted by the same reference numerals, and the description of the same portions is omitted.

It is determined whether or not the parallax direction of the stereoscopic image displayed on the display unit 170 and the parallax direction of the display unit 170 are coincident with each other (Step S911). Next, if the parallax directions are not coincident with each other (Step S911), it is determined whether or not the preference information retained in the preference information retention unit 121 indicates the setting that the displaying of the stereoscopic image is preferred (Step S931). In the case where the preference information indicates the setting that the displaying of the stereoscopic image is preferred (Step S931), the image process (rotation process) is performed on the stereoscopic image so that the parallax direction of the stereoscopic image displayed on the display unit 170 and the parallax direction of the display unit 170 are coincident with each other (Step S933). Next, the stereoscopic image which is subject to the image process is displayed on the display unit 170 (Step S921). In addition, in the case where the preference information does not indicates the setting that the displaying of the stereoscopic image is preferred (Step S931), the stereoscopic image is displayed as a planar image on the display unit 170 (Step S932). In addition, Steps S911 to S913, S921, S922, and S931 to S933 are examples of a control procedure disclosed in the embodiments of the present disclosure.

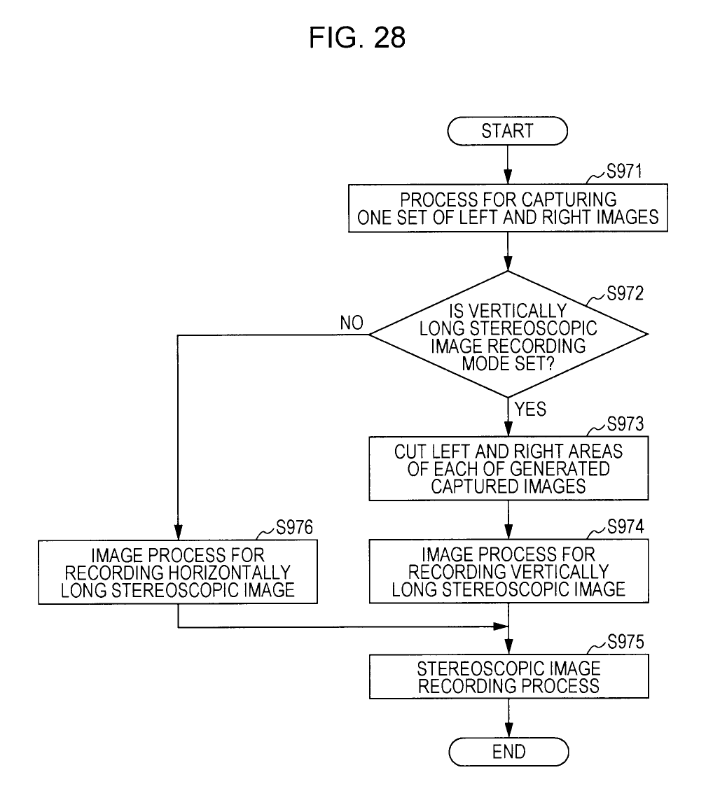

FIG. 28 is a flowchart illustrating an example of a process procedure of a stereoscopic image recording control process of the image capturing apparatus 100 according to the first embodiment of the present disclosure. This example illustrates an example of generating a vertically long stereoscopic image by cutting a predetermined area of at least one end portion side among the two end portions in the longitudinal direction of each of the left-eye viewing image and the right-eye viewing image (that is, the example corresponding to FIGS. 16A to 16D). In addition, this example illustrates the stereoscopic image recording control process at the time of performing the still image recording command manipulation in the state where the still image capturing mode is set.

First, the left-eye image capturing unit 210 and the right-eye image capturing unit 220 perform image capturing processes of generating the left-eye viewing image and the right-eye viewing image which are used to generate the stereoscopic image (Step S971). Subsequently, it is determined whether or not the vertically long stereoscopic image recording mode is set (Step S972).

In the case where the vertically long stereoscopic image recording mode is set (Step S972), the captured-image signal processing unit 230 generates the vertically long image by cutting predetermined left and right areas of each of the left-eye viewing image and the right-eye viewing image (Step S973). Subsequently, the captured-image signal processing unit 230 performs an image process for recording on the generated vertically long image (the left-eye viewing image and the right-eye viewing image) (Step S974). Subsequently, the recording control unit 260 performs the recording process for recording the vertically long image (the left-eye viewing image and the right-eye viewing image), which is subject to the image process, in the content storage unit 200 (Step S975).

In addition, in the case where the vertically long stereoscopic image recording mode is not set (Step S972), the captured-image signal processing unit 230 performs an image process for recording on the generated left-eye viewing image and the generated right-eye viewing image (Step S976), the procedure proceeds to Step S975. In other words, a normal image process for recording the stereoscopic image is performed.

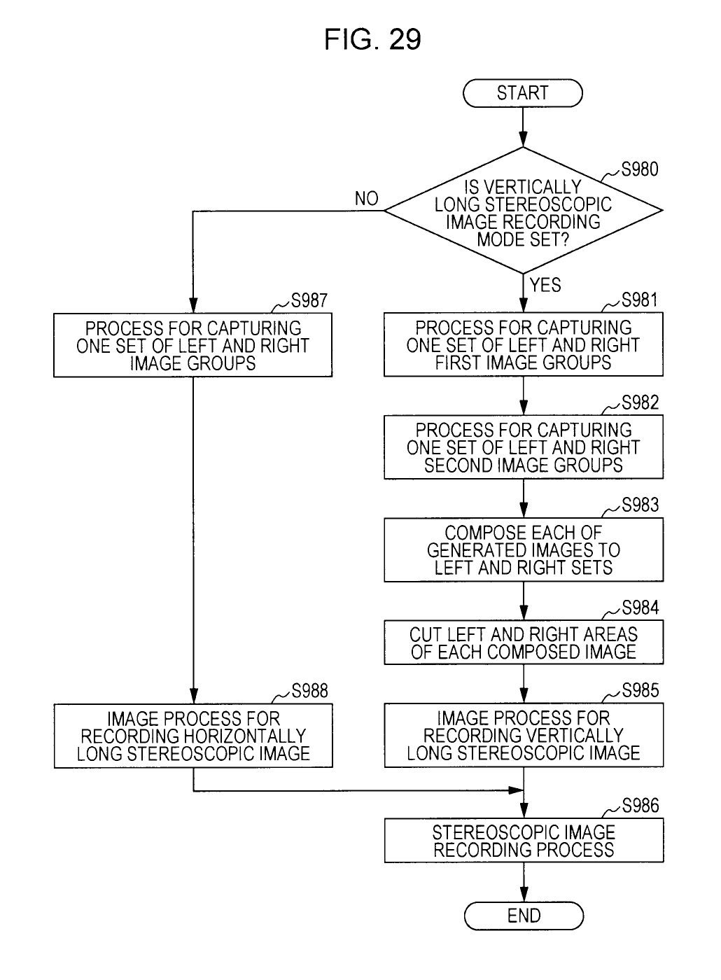

FIG. 29 is a flowchart illustrating an example of a process procedure of the stereoscopic image recording control process of the image capturing apparatus 100 according to the first embodiment of the present disclosure. This example illustrates an example of generating the two images which are consecutively disposed or overlapped in the vertical direction and composing the two generated images to generate the vertically long stereoscopic image (that is, the example corresponding to FIGS. 17A to 17C and FIGS. 18A to 18C). In addition, this example illustrates the stereoscopic image recording control process of the time of performing the still image recording command manipulation in the state where the still image capturing mode is set.

First, it is determined whether or not the vertically long stereoscopic image recording mode is set (Step S980). In the case where the vertically long stereoscopic image recording mode is set (Step S980), the left-eye image capturing unit 210 and the right-eye image capturing unit 220 perform the image capturing process for generating one set of the first image groups (the left-eye viewing image and the right-eye viewing image) (Step S981). Subsequently, the left-eye image capturing unit 210 and the right-eye image capturing unit 220 perform the image capturing process for generating one set of the second image group (the left-eye viewing image and the right-eye viewing image) used for generating the stereoscopic image (Step S982).

Subsequently, the captured-image signal processing unit 230 generates the composed images (the left-eye viewing image and the right-eye viewing image) by composing the two consecutive images to be overlapped at each of the left and right sides based on the correlation between the images included in the generated first and second image groups (Step S983). Subsequently, the captured-image signal processing unit 230 generates the vertically long image by cutting predetermined left and right areas of each of the generated composed images (the left-eye viewing image and the right-eye viewing image) (Step S984). Subsequently, the captured-image signal processing unit 230 performs an image process for recording on the generated vertically long image (the left-eye viewing image and the right-eye viewing image) (Step S985). Subsequently, the recording control unit 260 performs the recording process for recording the vertically long image (the left-eye viewing image and the right-eye viewing image), which is subject to the image process, in the content storage unit 200 (Step S986).

In addition, in the case where the vertically long stereoscopic image recording mode is not set (Step S980), the left-eye image capturing unit 210 and the right-eye image capturing unit 220 perform image capturing processes for generating the left-eye viewing image and the right-eye viewing image (one set of left and right image groups) (Step S987). Subsequently, the captured-image signal processing unit 230 performs an image process for recording on the generated left-eye viewing image and the generated right-eye viewing image (Step S988), and the procedure proceeds to Step S986. In other words, a normal image process for recording the stereoscopic image is performed.

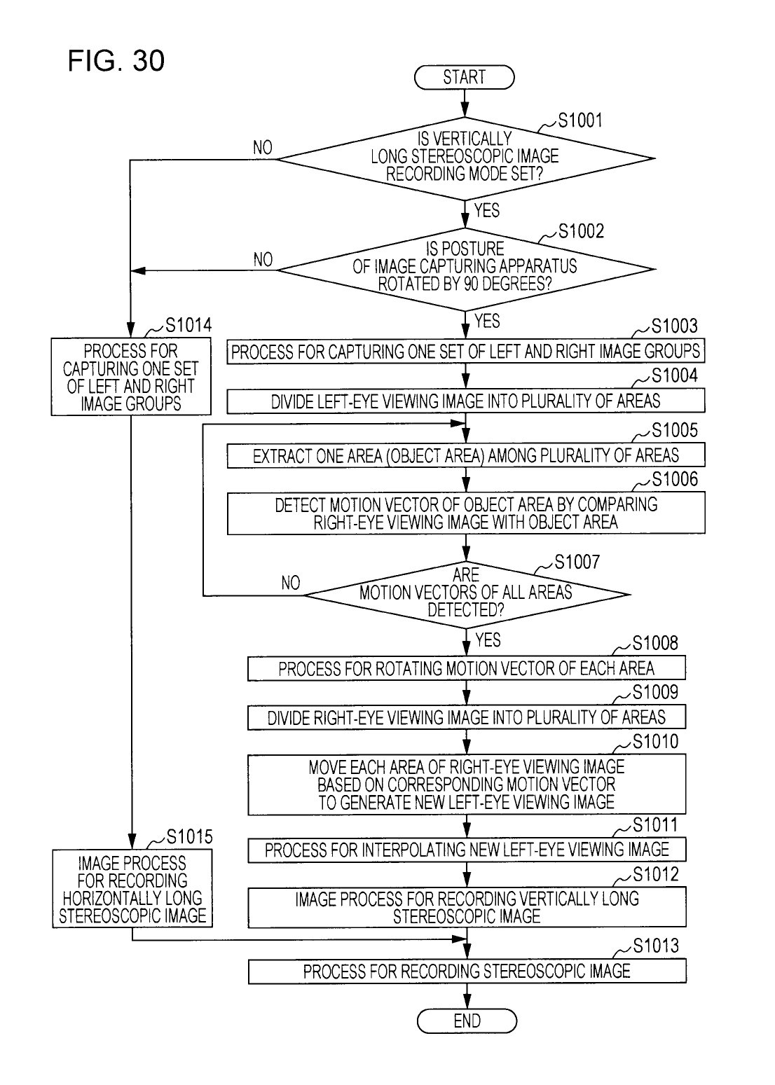

FIG. 30 is a flowchart illustrating an example of a process procedure of the stereoscopic image recording control process of the image capturing apparatus 100 according to the first embodiment of the present disclosure. This example illustrates an example of dividing the image into a plurality of areas and changing the parallax direction of the stereoscopic image by using the motion vectors of the divided areas (that is, the example corresponding to FIGS. 22A to 22C to FIGS. 24A and 24B). In addition, this example illustrates the stereoscopic image recording control process of the time of performing the still image recording command manipulation in the state where the still image capturing mode is set.

First, it is determined whether or not the vertically long stereoscopic image recording mode is set (Step S1001). In the case where the vertically long stereoscopic image recording mode is set (Step S1001), it is determined based on the result of the detection from the image capturing posture detection unit 250 whether or not the posture of the image capturing apparatus 100 is the posture which is rotated by 90 degrees by using the optical axis direction as a rotation axis (Step S1002). In the case where the posture of the image capturing apparatus 100 is the 90-degree-rotated posture (Step S1002), the left-eye image capturing unit 210 and the right-eye image capturing unit 220 performs the image capturing process for generating the left-eye viewing image and the right-eye viewing image (one set of the image group) (Step S1003).

Subsequently, the captured-image signal processing unit 230 divides the left-eye viewing image into a plurality of areas (Step S1004). Subsequently, the captured-image signal processing unit 230 extracts one area (object area) as an object of comparison from the divided areas of the left-eye viewing image (Step S1005). Subsequently, the captured-image signal processing unit 230 searches the area of the right-eye viewing image, of which the correlation to the image included in the object area is highest, and detects the motion vector based on a result of the searching (Step S1006).

Subsequently, it is determined whether or not the detection process for the motion vector is ended with respect to all the areas of the left-eye viewing image (Step S1007). In the case where the detection process for the motion vector is not ended with respect to all the areas, the process returns to Step S1005. On the other hand, in the case where the detection process for the motion vector is ended with respect to all the areas of the left-eye viewing image (Step S1007), the rotation process for the motion vector is performed (Step S1008). In other words, the captured-image signal processing unit 230 performs the rotation process for rotating the motion vectors, which are detected in the areas of the left-eye viewing image, by only a predetermined angle (for example, 90 degrees clockwise) (Step S1008). Subsequently, the captured-image signal processing unit 230 divides the right-eye viewing image into areas of which the size is equal to the size of the areas which the left-eye viewing image is divided into (Step S1009).

Subsequently, the captured-image signal processing unit 230 moves each of the areas of the right-eye viewing image based on the motion vector detected with respect to each of the areas of the left-eye viewing image to generate a new left-eye viewing image (Step S1010). Subsequently, the captured-image signal processing unit 230 performs an interpolation process on the newly generated left-eye viewing image (Step S1011). Subsequently, the captured-image signal processing unit 230 performs an image process for recording on the new left-eye viewing image which is subject to the interpolation process and the original right-eye viewing image (Step S1012). Subsequently, the recording control unit 260 performs a recording process for recording the two images (the vertically long images (the left-eye viewing image and the right-eye viewing image)), which is subject to the image process, in the content storage unit 200 (Step S1013).

In addition, in the case where the vertically long stereoscopic image recording mode is not set (Step S1001), or in the case where the posture of the image capturing apparatus 100 is the 90-degree-rotated posture (Step S1002), image capturing processes for capturing one set of the left and right image groups are performed (Step S1014). In other words, the left-eye image capturing unit 210 and the right-eye image capturing unit 220 perform the image capturing processes for generating the left-eye viewing image and the right-eye viewing image (one set of the left and right image groups). Subsequently, the captured-image signal processing unit 230 performs an image process for recording on the generated left-eye viewing image and the generated right-eye viewing image (Step S1015), the procedure proceeds to Step S1013. In other words, a normal image process for recording the stereoscopic image is performed.

In addition, in the examples illustrated in FIG. 28 to FIG. 30, although the stereoscopic image recording control process at the time of performing the still image recording command manipulation in the state where the still image capturing mode is set is illustrated, the present disclosure may also be adapted to the stereoscopic image recording control process for recording a moving image. For example, in the case of recording the moving image, the vertically long stereoscopic images are generated with respect to the frames constituting the moving image, and the generated stereoscopic images are sequentially recorded as a moving image file.

In addition, in the examples illustrated in FIG. 28 to FIG. 30, although the stereoscopic image recording control process is illustrated, the present disclosure may also be adapted to the stereoscopic image display control process for displaying a still image or a moving image. In this case, for example, the vertically long stereoscopic image is generated based on the image content stored in the content storage unit 200, and the generated vertically long stereoscopic image is displayed on the display unit 170.

In addition, the first embodiment of the present disclosure illustrates the example where the display unit 170 and the main body (the first casing 101) are configured as different cases and the posture-of-display-unit detection unit 180 detects the rotation state of the display unit 170 with respect to the main body. However, the first embodiment of the present disclosure may be adapted to an image capturing apparatus or an image processing apparatus such as a mobile phone apparatus where the display unit and the main body are configured as an integral body. For example, a posture detection unit (for example, an acceleration sensor) which detects the posture (for example, the vertical state or the horizontal state) of the display unit (the mainly body of the apparatus) may be provided to the image processing apparatus, so that the various controls may be performed by using a result of the detection by the posture detection unit. For example, based on the result of the detection, the parallax direction of the display unit may be changed, or it may be determined whether or not the parallax direction of the stereoscopic image and the parallax direction of the display unit are coincident with each other.

### 2. Modified Example

The first embodiment of the present disclosure is described with respect to the example of using the parallax barrier type as a display type for displaying the stereoscopic image. However, the first embodiment of the present disclosure may be adapted to types other than the parallax barrier type. Therefore, hereinafter, a modified example of the first embodiment of the present disclosure is illustrated. The configuration of the image capturing apparatus according to the modified example is substantially the same as the example illustrated in FIGS. 1A to 10 and FIG. 2 except that the type for displaying the stereoscopic image is different and the parallax direction of the user is acquired. Therefore, the same portions as (or the portions corresponding to) the first embodiment of the present disclosure are denoted by the same reference numerals, and a portion of the description is omitted.

### [Example of Type of Displaying Stereoscopic Image (Special-Purpose Glasses Type)]

FIGS. 31A and 31B are schematic diagrams illustrating an example (special-purpose glasses type) of a display type for displaying a stereoscopic image on an image processing apparatus 700 (display unit 710) according to a modified example of the first embodiment of the present disclosure. FIG. 31A schematically illustrates a special-purpose glasses type as an example of a type for displaying the stereoscopic image on the display unit 710. This type is a type where a user wears special-purpose glasses (for example, active shutter type glasses or polarizer type glasses) 720 for seeing a stereoscopic image and the stereoscopic image is supplied to the user. In this example, the case where the user wears the active shutter type glasses (shutter mechanism attached glasses) as the special-purpose glasses 720 and the stereoscopic image is displayed is considered in the description.

The image processing apparatus 700 includes a display unit 710, a synchronization signal transmitting unit 711, and a parallax direction receiving unit 712. In addition, the special-purpose glasses 720 include a synchronization signal receiving unit 721 and a parallax direction acquisition unit 722.

Herein, the case where the user wears the special-purpose glasses 720 and sees the stereoscopic image is considered. In this case, the image processing apparatus 700 (the display control unit 160 illustrated in FIG. 2) allows the stereoscopic image which becomes the display object to be displayed on the display unit 710 in a frame sequential display type (a type where the right-eye image and the left-eye image are alternately displayed). In addition, synchronization signals are sequentially transmitted from the synchronization signal transmitting unit 711 to the synchronization signal receiving unit 721. Accordingly, the liquid crystal shutter (electronic shutter) corresponding to the lens section of the lens section of the special-purpose glasses 720 is synchronized with the right-eye image and the left-eye image which are alternately displayed on the display unit 710. In other words, the special-purpose glasses 720 alternately opens and closes the liquid crystal shutter which corresponds to the lens section of the special-purpose glasses 720 in synchronization with the right-eye image and the left-eye image which are alternately displayed on the display unit 710.

In addition, the parallax direction acquisition unit 722 detects a change of the posture of the special-purpose glasses 720 by detecting acceleration, motion, tilt, and the like of the special-purpose glasses 720 and acquires the parallax direction of the user based on the result of the detection. Next, the acquired parallax directions of the user are sequentially transmitted from the special-purpose glasses 720 to the parallax direction receiving unit 712. Accordingly, it may be determined whether or not the parallax direction of the user (the posture of the special-purpose glasses 720) and the parallax direction of the stereoscopic image (the posture of the display unit 710) are coincident with each other. In addition, the parallax direction acquisition unit 722 may be implemented by a gyro sensor (angular velocity sensor) or an acceleration sensor.

FIG. 31B schematically illustrates a relationship in a time axis between the stereoscopic image displayed on the display unit 710 and the images which reach the left and right eyes of the user through the special-purpose glasses 720. In addition, the horizontal axis illustrated in FIG. 31B is set to the time axis.

More specifically with respect to the stereoscopic image (displayed image 731) displayed on the display unit 710, the left-eye viewing image and the right-eye viewing image are schematically illustrated by “L” and “R” in the time axis. In addition, with respect to the images reaching the user through the special-purpose glasses 720, the image (the image 732 transmitting through the right lens) which reaches the user's right eye through the right-eye lens is schematically illustrated by “R” in the time axis. Similarly, the image (the image 733 transmitting through the left lens) which reaches the user's left eye through the left-eye lens is schematically illustrated by “L” in the time axis.

In other words, in the case where the right-eye image “R” is displayed on the display unit 710, the left glass of the special-purpose glasses 720 is closed. On the other hand, in the case where the left-eye image “L” is displayed on the display unit 710, the right glass of the special-purpose glasses 720 is closed. In this manner, the images displayed on the display unit 710 are seen by the user using the special-purpose glasses 720, so that the stereoscopic image may be properly seen.

Herein, in the case where the stereoscopic image is seen by using the special-purpose glasses 720, the parallax direction of the display unit 710 is changed according to a change of the parallax direction of the user (that is, a change of the posture of the special-purpose glasses 720). Therefore, the image processing apparatus 700 (the controller 120 illustrated in FIG. 2) determines whether or not the parallax direction of the user specified according to the posture of the special-purpose glasses 720 is coincident with the parallax direction of the stereoscopic image displayed on the display unit 710 and performs the aforementioned various controls based on a result of the determination.

Herein, for example, in the case where the user's head is tilted, it may be considered that the parallax direction of the user is rotated by 45 degrees by using the eye direction as a rotation axis. In this manner, in the case where the change in the parallax direction of the user is the rotation of less than 90 degrees, for example, the example illustrated in FIGS. 22A to 22C to FIGS. 24A and 24B may be employed, so that the parallax direction of the stereoscopic image may be changed. In this case, for example, the rotation angle of the motion vector illustrated in FIG. 23B is set to the angle corresponding to the change in the parallax direction of the user, so that an image of a new viewing point may be generated.

### 3. Modified Example

In the first embodiment of the present disclosure, the example of generating the two images (the two images used for displaying the stereoscopic image) by using the two optical systems and the two image capturing devices is illustrated. However, the two images may be configured to be generated by using one image capturing device. In addition, the first embodiment of the present disclosure may be adapted to a case of generating a multi-viewing-point image by using an image capturing apparatus having other configurations. Therefore, hereinafter, a modified example of the first embodiment of the present disclosure is illustrated. The configuration of the image capturing apparatus of the modified example is substantially the same as the example illustrated in FIGS. 1A to 10 and FIG. 2 except for different points of the outer appearance, the image capturing unit, and the like. Therefore, the same portions as (or the portions corresponding to) the first embodiment of the present disclosure are denoted by the same reference numerals, and a portion of the description is omitted.

### [Example of Configuration of Image Capturing Apparatus]

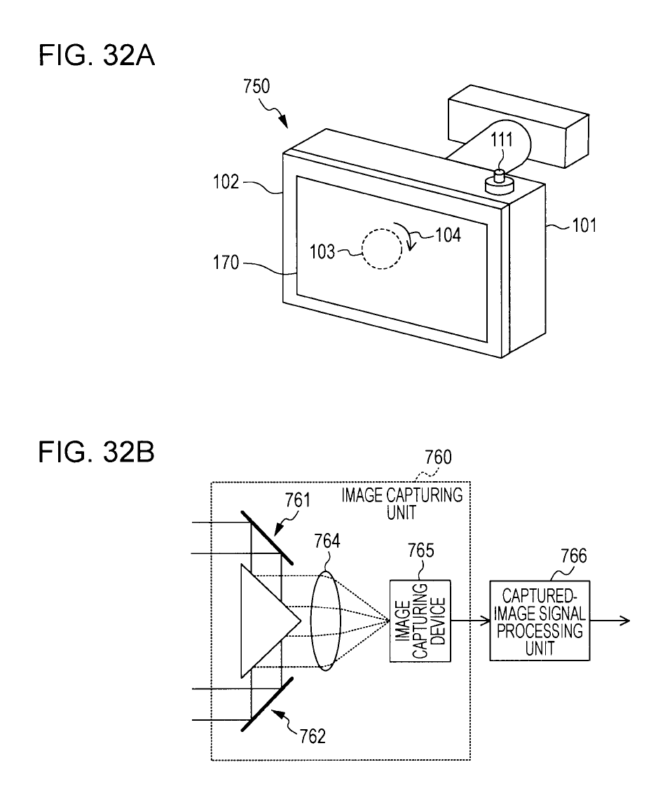

FIGS. 32A and 32B are diagrams illustrating an example of a configuration of outer appearance and an example of a functional configuration of an image capturing apparatus 750 according to a modified example of the first embodiment of the present disclosure. FIG. 32A illustrates outer appearance of a rear surface side of the image capturing apparatus 750; and FIG. 32B illustrates the example of functional configuration of the image capturing apparatus 750. In addition, only the image capturing unit 760 and the captured-image signal processing unit 766 are illustrated in FIG. 32B; and since other configurations are substantially the same as those of the example illustrated in FIG. 2, other configurations are omitted in the description and illustration.

As illustrated in FIG. 32B, the image capturing unit 760 includes one image capturing device 765, two optical systems 761 and 762 using an adapter and the like, and a lens 764.

### [Example of Configuration of Image Capturing Apparatus]

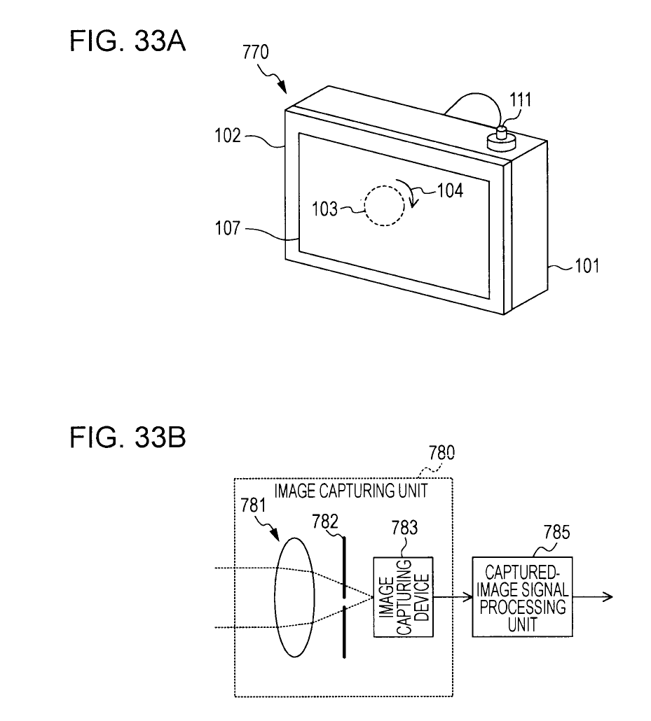

FIGS. 33A and 33B are diagrams illustrating an example of a configuration of outer appearance and an example of a functional configuration of an image capturing apparatus 770 according to a modified example of the first embodiment of the present disclosure. FIG. 33A illustrates outer appearance of a rear surface side of the image capturing apparatus 770; and FIG. 33B illustrates the example of functional configuration of the image capturing apparatus 770. In addition, only the image capturing unit 780 and the captured-image signal processing unit 785 are illustrated in FIG. 33B; and since other configurations are substantially the same as those of the example illustrated in FIG. 2, other configurations are omitted in the description and illustration.

As illustrated in FIG. 33B, the image capturing unit 780 includes one optical system 781 and one image capturing device 783, and a shutter 782 which divides the left and right images is disposed between the optical system 781 and the image capturing device 783.

### [Example of Configuration of Mobile Phone Apparatus]

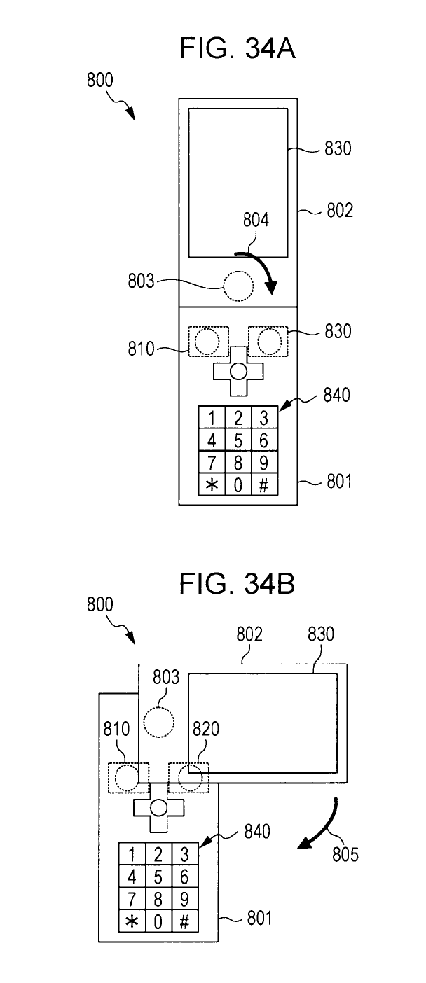

Hereinbefore, the examples of using the image capturing apparatus are described. However, the first embodiment of the present disclosure may be adapted to other image processing apparatuses having a display unit. In addition, the first embodiment of the present disclosure may be adapted to an image processing apparatus capable of displaying a stereoscopic image or a planar image on an external display apparatus. For example, the first embodiment of the present disclosure may be adapted to a mobile phone apparatus having a display unit. The mobile phone apparatus is illustrated in FIGS. 34A and 34B.

FIGS. 34A and 34B are diagrams illustrating an example of configuration of outer appearance of a mobile phone apparatus 800 according to a modified example of the first embodiment of the present disclosure. FIG. 34A illustrates a front side of the one example of the usage of the mobile phone apparatus 800. In addition, FIG. 34B illustrates a front side of another example of the usage of the mobile phone apparatus 800.

The mobile phone apparatus 800 includes a first casing 801 and a second casing 802. In addition, the first casing 801 and the second casing 802 are rotatably connected to each other by using a rotating member 803 as a rotation reference. The mobile phone apparatus 800 is implemented, for example, by a mobile phone apparatus (so-called a camera-attached mobile phone apparatus) having a plurality of image capturing functions. In addition, in FIGS. 34A and 34B, for convenience of the description, the mobile phone apparatus 800 is simplified in the illustration, and a power switch or the like which is disposed on an outer side surface of the mobile phone apparatus 800 is omitted in the illustration.

The first casing 801 includes a left-eye image capturing unit 810, a right-eye image capturing unit 820, and a manipulation unit 840. The second casing 802 includes a display unit 830. The left-eye image capturing unit 810 and the right-eye image capturing unit 820 correspond to the left-eye image capturing unit 210 and the right-eye image capturing unit 220 illustrated in FIG. 2 or the like. In addition, the manipulation unit 840 includes number pads for inputting numbers, symbols, or the like, an enter key which is pressed at the time of, for example, setting various functions by the user, a +-shaped key which is used to, for example, change a selected state displayed on the display screen, and the like. In addition, the mobile phone apparatus 800 is configured so that lenses constituting the left-eye image capturing unit 810 and the right-eye image capturing unit 820 are installed in the rear surface side (that is, the surface of the front surface side illustrated in FIGS. 34A and 34B). Therefore, in FIGS. 34A and 34B, the lenses are indicated by dotted lines drawn at the positions on the front surface side corresponding to the left-eye image capturing unit 810 and the right-eye image capturing unit 820.

As described above, the first casing 801 and the second casing 802 are rotatably connected to each other. In other words, the second casing 802 may be rotated with respect to the first casing 801 by using the rotating member 803 (indicated by a dotted line) as a rotation reference. Accordingly, a relative position relationship of the second casing 802 with respect to the first casing 801 may be changed. For example, the state where the second casing 802 is rotated by 90 degree in the direction of arrow 804 illustrated in FIG. 34A is illustrated in FIG. 34B.

In addition, the mobile phone apparatus 800 illustrated in FIG. 34B is the same as the example illustrated in FIG. 34A except that the second casing 802 is rotated by 90 degree with respect to the first casing 801 by using the rotating member 803 as a rotation reference. In addition, if the second casing 802 is further rotated by 90 degrees in the direction of arrow 805 in the state illustrated in FIG. 34B, so-called closed state is obtained.

As described hereinbefore, according to the first embodiment of the present disclosure, in the case where the stereoscopic image (multi-viewing-point image) is displayed, the parallax direction of the display unit and the parallax direction of the stereoscopic image may be allowed to be coincident with each other, so that it is possible to prevent the stereoscopic image which arouses uncomfortable feelings in a user from being displayed.

In addition, in the case where the direction of the image is set to be preferred, the stereoscopic image which arouses uncomfortable feelings in a user is not displayed, but the stereoscopic image may be displayed as a planar image.

In addition, the stereoscopic image may be displayed at the image capturing operation time for the vertically long stereoscopic image, and the multi-viewing-point image of which the parallax direction is appropriate may be generated without addition of mechanical and optical mechanisms for only the vertically long image capturing operation.

In addition, although the embodiment of the present disclosure is described with respect to the example using the two-viewing-point image as a multi-viewing-point image, the embodiment of the present disclosure may be adapted to a multi-viewing-point image having three or more viewing points.

In addition, the embodiment of the present disclosure illustrates an example for embodying the present disclosure, and as clarified in the embodiment, the components therein and the components specified in the claims of the present disclosure have a relationship of correspondence. Similarly, the components specified in the claims of the present disclosure and the components in the embodiment of the present disclosure to which the same names are allocated have a relationship of correspondence. However, the present disclosure is not limited to the embodiment, but various modifications of the embodiment are available for embodying the present disclosure within a range without departing from the spirit of the present disclosure.

In addition, the process procedure described in the embodiment of the present disclosure may be considered to be a method having a series of procedures. In addition, the process procedure may be considered to be a program for allowing a computer to execute a series of the procedures or a recording medium storing the program. As the recording medium, for example, a CD (Compact Disc), an MD (Mini Disc), a DVD (Digital Versatile Disc), a memory card, and Blu-ray Disc (registered trade mark)), or the like may be used.

The present disclosure contains subject matter related to that disclosed in Japanese Priority Patent Application JP 2010-176897 filed in the Japan Patent Office on Aug. 6, 2010, the entire contents of which are hereby incorporated by reference.

What is claimed is:

1. An image processing apparatus comprising:
an acquisition unit which acquires stereoscopic image information used for displaying a stereoscopic image on a display unit;
a controller which performs one of a first control of allowing the stereoscopic image to be displayed as a planar image on the display unit and a second control of performing an image process on the stereoscopic image so that a parallax direction of the stereoscopic image and a parallax direction of the display unit are coincident with each other and allowing the stereoscopic image, which is subject to the image process, to be displayed on the display unit in the case where a parallax direction of the stereoscopic image displayed on the display unit and a parallax direction of the display unit are not coincident with each other based on the stereoscopic image information.

2. The image processing apparatus according to claim 1, wherein in the case of performing the second control, the controller performs control of performing a rotation process on the stereoscopic image so that the parallax direction of the stereoscopic image and the parallax direction of the display unit are coincident with each other and allowing the stereoscopic image, which is subject to the rotation process, to be displayed on the display unit.

3. The image processing apparatus according to claim 1 further comprising a manipulation receiving unit which receives rotation command manipulation for rotating the stereoscopic image which is to be displayed on the display unit,
wherein if the rotation command manipulation is received in the case where the stereoscopic image is displayed on the display unit, the controller performs the first control in the case where the parallax direction of the stereoscopic image and the parallax direction of the display unit are not coincident with each other.

4. The image processing apparatus according to claim 3,
wherein the manipulation receiving unit receives returning command manipulation for returning the rotation, which is based on the rotation command manipulation after receiving the rotation command manipulation, to an original state, and
wherein after the returning command manipulation is received in the case where the stereoscopic image is displayed on the display unit, the controller performs the second control in the case where the parallax direction of the stereoscopic image and the parallax direction of the display unit are not coincident with each other.

5. The image processing apparatus according to claim 1,
wherein the stereoscopic image is configured by using multi-viewing-point images, and
wherein in the case where the first control is performed, the controller performs control of allowing at least one viewing point image among the multi-viewing-point images to be displayed on the display unit.

6. The image processing apparatus according to claim 1,
wherein the stereoscopic image information includes parallax information indicating the parallax direction of the stereoscopic image, which is displayed on the display unit based on the stereoscopic image information, at an image capturing operation time, and
wherein the controller determines based on the parallax information included in the acquired stereoscopic image information whether or not the parallax direction of the stereoscopic image and the parallax direction of the display unit are coincident with each other.

7. The image processing apparatus according to claim 1, further comprising:
a first casing having the display unit;
a second casing which is a casing different from the first casing;
a rotating member which rotatably connects the first casing and the second casing; and
a detection unit which detects a rotation state of the first casing with respect to the second casing,
wherein the stereoscopic image information includes parallax information indicating the parallax direction of the stereoscopic image, which is displayed on the display unit based on the stereoscopic image information, at an image capturing operation time, and
wherein the controller determines based on the parallax information included in the acquired stereoscopic image information and the detected rotation state of the first casing whether or not the parallax direction of the stereoscopic image and the parallax direction of the display unit are coincident with each other.

8. The image processing apparatus according to claim 7,
wherein the display unit is set so that one of a specific direction of the display screen and an orthogonal direction directing to the display screen is the parallax direction, and
wherein the controller performs control of changing the parallax direction of the display unit based on the detected rotation state of the first casing.

9. The image processing apparatus according to claim 8, wherein in the case where the parallax direction of the stereoscopic image displayed on the display unit and the parallax direction of the display unit are not coincident with each other, the controller performs one of the first control, the second control, and a third control of changing the parallax direction of the display unit so that the parallax direction of the display unit is coincident with the parallax direction of the stereoscopic image and allowing the stereoscopic image to be displayed on the display unit.

10. The image processing apparatus according to claim 1,
wherein the display unit is set so that one of a specific direction of the display screen and an orthogonal direction directing to the display screen is the parallax direction, and
wherein the controller changes the parallax direction of the display unit based on user manipulation or a posture of the display unit and determines whether or not the changed parallax direction of the display unit and the parallax direction of the stereoscopic image are coincident with each other.

11. The image processing apparatus according to claim 1, further comprising a manipulation receiving unit which receives selection manipulation for selecting whether the controller is allowed to perform the first control or the controller is allowed to perform the second control in the case where the parallax direction of the stereoscopic image displayed on the display unit and the parallax direction of the display unit are not coincident with each other,
wherein in the case where the parallax direction of the stereoscopic image displayed on the display unit and the parallax direction of the display unit are not coincident with each other, the controller allows the image corresponding to the acquired stereoscopic image information to be displayed on the display unit according to the selected control.

12. The image processing apparatus according to claim 1,
wherein the stereoscopic image is configured by using two-viewing-point images of a first image and a second image,
wherein the image processing apparatus further comprises:
a detection unit which detects movement amounts and movement directions of a plurality of areas of the first image with respect to the second image based on the first image and the second image; and
a composition unit which moves images of a plurality of areas of the second image based on the detected movement amounts and movement directions of the areas of the first image and generates a composed image based on the moved images, and
wherein in the case where the second control is performed, the controller allows the generated composed image and the second image to be displayed as the stereoscopic image on the display unit.

13. The image processing apparatus according to claim 1, further comprising:
an image capturing unit which image-captures a subject to generate a first image and a second image used for displaying the stereoscopic image for stereoscopically viewing the subject;
a detection unit which detects movement amounts and movement directions of a plurality of areas of the first image with respect to the second image based on the generated first and second images;
a composition unit which moves images of a plurality of areas of the second image based on the detected movement amounts and movement directions of the areas of the first image and generates a composed image based on the moved images; and
a recording control unit which allows the generated composed image and the second image to be recorded as multi-viewing-point images included in the stereoscopic image information on a recording medium.

14. The image processing apparatus according to claim 1, further comprising:
an image capturing unit which image-captures a subject to generate multi-viewing-point images used for displaying the stereoscopic image for stereoscopically viewing the subject;
an image cutting unit which cuts a predetermined area of at least one end portion side among the two end portions in the longitudinal direction in each of the generated multi-viewing-point images; and
a recording control unit which allows the multi-viewing-point images, in which the predetermined area is cut, to be included in the stereoscopic image information and to be recorded on a recording medium.

15. The image processing apparatus according to claim 1, further comprising:
an image capturing unit which image-captures a subject to generate a plurality of sets of image groups where sets of multi-viewing-point images used for displaying the stereoscopic image for stereoscopically viewing the subject are consecutively disposed in a time sequence;
a composition unit which performs composition by using at least a portion of each of the plurality of the generated sets of the image groups to generate a plurality of composed images used for displaying the stereoscopic image for stereoscopically viewing the subject; and
a recording control unit which allows the plurality of generated composed images to be recorded as multi-viewing-point images in the stereoscopic image information on a recording medium.

16. An image processing apparatus comprising:
a parallax direction acquisition unit which acquires a parallax direction of a user;
an acquisition unit which acquires stereoscopic image information used for displaying a stereoscopic image on a display unit; and
a controller which performs one of a first control of allowing the stereoscopic image to be displayed as a planar image on the display unit, a second control of performing an image process on the stereoscopic image so that a parallax direction of the stereoscopic image and the acquired parallax direction are coincident with each other and allowing the stereoscopic image, which is subject to the image process, to be displayed on the display unit, and a third control of changing the parallax direction of the display unit so that the parallax direction of the stereoscopic image and the acquired parallax direction are coincident with each other and allowing the stereoscopic image to be displayed on the display unit in the case where the parallax direction of the stereoscopic image displayed on the display unit and the acquired parallax direction are not coincident with each other based on the stereoscopic image information.

17. An image processing apparatus comprising:
an acquisition unit which acquires stereoscopic image information used for displaying a stereoscopic image on a display unit; and
a controller which performs control of allowing the stereoscopic image to be displayed as a planar image on the display unit in the case where the parallax direction of the stereoscopic image displayed on the display unit and the parallax direction of the display unit are not coincident with each other based on the stereoscopic image information.

18. An image processing apparatus comprising:
an acquisition unit which acquires stereoscopic image information used for displaying a stereoscopic image on a display unit; and
a controller which performs control of performing an image process on the stereoscopic image so that a parallax direction of the stereoscopic image and a parallax direction of the display unit are coincident with each other and allowing the stereoscopic image, which is subject to the image process, to be displayed on the display unit in the case where the parallax direction of the stereoscopic image displayed on the display unit and the parallax direction of the display unit are not coincident with each other based on the stereoscopic image information.

19. An image processing method comprising:
acquiring stereoscopic image information used for displaying a stereoscopic image on a display unit;
performing an image process on the stereoscopic image so that a parallax direction of the stereoscopic image and a parallax direction of the display unit are coincident with each other and allowing the stereoscopic image, which is subject to the image process, to be displayed on the display unit in the case where the parallax direction of the stereoscopic image displayed on the display unit and the parallax direction of the display unit are not coincident with each other based on the stereoscopic image information.

20. A program allowing a computer to execute:
acquiring stereoscopic image information used for displaying a stereoscopic image on a display unit; and
performing an image process on the stereoscopic image so that a parallax direction of the stereoscopic image and a parallax direction of the display unit are coincident with each other and allowing the stereoscopic image, which is subject to the image process, to be displayed on the display unit in the case where the parallax direction of the stereoscopic image displayed on the display unit and the parallax direction of the display unit are not coincident with each other based on the stereoscopic image information.
